(19) United States
(12) Patent Application Publication
(10) Pub. No.: US 2002/0008820 A1
(43) Pub. Date: Jan. 24, 2002

(54) Liquid crystal display apparatus

(75) Inventors: Tsukasa Yagi, Kobe-Shi (JP); Masaaki Nakai, Suita-Shi (JP); Eiji Yamakawa, Sanda-Shi (JP); Kazuaki Okumura, Ikeda-Shi (JP); Hiroshi Nittaya, Izumisano-Shi (JP); Katsuhiko Asai, Takatsuki-Shi (JP)

Correspondence Address: SIDLEY AUSTIN BROWN & WOOD, 717 NORTH HARWOOD, SUITE 3400, DALLAS, TX, 75201, US

(73) Assignee: MINOLTA CO., LTD.

(21) Appl. No.: 09/891,997

(22) Filed: Jun. 26, 2001

(30) Foreign Application Priority Data
Jun. 30, 2000 (JP) 2000-200288
Jun. 30, 2000 (JP) 2000-200289
Mar. 30, 2001 (JP) 2001-102429
Apr. 27, 2001 (JP) 2001-130712

(51) Int. Cl. G02F 1/1343

(52) U.S. Cl. 349/139

(57) ABSTRACT

A liquid crystal display apparatus which has a liquid crystal display and a controller. The liquid crystal display has a plurality of rectangular pixels arranged in a matrix, a plurality of scanning electrodes extending in the direction parallel to the longer sides of the rectangular pixels, a plurality of signal electrodes extending in the direction orthogonal to the longer sides of the rectangular pixels. The controller is to drive the scanning electrodes and the signal electrodes. An image is written on the liquid crystal display by using a driving pulse for carrying out writing after resetting the liquid crystal and by carrying out interlace scanning with one frame divided into a plurality of fields. The pixel pitch in the vertical direction is 1/n (for example, 1/1.5) of the pixel pitch in the horizontal direction. If the pixel pitch in the vertical direction is 1/1.5 of the pixel pitch in the horizontal direction, display data to be displayed on the liquid crystal display are produced by allocating original image data for two pixels Y1′ and Y2′ to three pixels Y1, Y2 and Y3. The liquid crystal display may have a first display area and a second display area, and the widths and the pitch of the scanning electrodes in the second display area may be, for example, 1/2 of those of the scanning electrodes in the first display area.

### BACKGROUND OF THE INVENTION

1. Field of the Invention

The present invention relates to a liquid crystal display apparatus, and more particularly to a liquid crystal display apparatus which comprises a plurality of pixels which are made of liquid crystal and which are arranged in a matrix.

2. Description of Related Art

In recent years, liquid crystal displays which use chiral nematic liquid crystal which exhibits a cholesteric phase at room temperature attract attention because such liquid crystal displays have a memory effect and accordingly are capable of displaying images thereon continuously even after stoppage of supplies of electric power thereto.

In such a liquid crystal display, however, it is necessary to reset the liquid crystal before writing thereon, and it takes a long time to write an image thereon. This causes the following problem: during writing, in the part subjected to the writing, the light absorbing layer on the backside of the liquid crystal display is seen as black lines (blackout), and the screen is difficult to see.

### SUMMARY OF THE INVENTION

An object of the present invention is to provide a liquid crystal display apparatus which has a high resolution and which is capable of carrying out interlace scanning without degrading display performance.

Another object of the present invention is to provide a liquid crystal display apparatus which can be produced easily at low cost.

Further, another object of the present invention is to provide a liquid crystal display apparatus which attains less power consumption by preventing the frequency of a clock signal, which is used for sending of image data, from becoming higher.

In order to attain the objects, a first liquid crystal display apparatus according to the present invention comprises: a liquid crystal layer comprising liquid crystal; a plurality of scanning electrodes aligned in a first direction at a first pitch, each of the first scanning electrodes extending in a second direction substantially orthogonal to the first direction; and a plurality of signal electrodes facing the scanning electrodes with the liquid crystal layer sandwiched between the signal electrodes and the scanning electrodes, the signal electrodes being aligned in the second direction at a second pitch wider than the first pitch and each of the signal electrodes extending in the first direction.

A plurality of pixels are formed on the intersections between the scanning electrodes and the signal electrodes. Each of the pixels is substantially a rectangle of which shorter sides are parallel to the first direction and of which longer sides are parallel to the second direction.

In the first liquid crystal display apparatus, the resolution in the first direction (the direction in which the scanning electrodes are aligned) is higher than that of original image data, and it is possible to write a quality image by interlace scanning without causing a blackout.

The first liquid crystal display apparatus may further comprise a controller which uses a driving pulse to reset the liquid crystal and then to write an image thereon and carries out interlace scanning with one frame divided into a plurality of fields. During the writing by interlace scanning, scanning lines along the scanning electrodes which are subjected to writing are scattered finely. Accordingly, blackout is not remarkable, and the display performance is improved. The resolution in the direction in which the signal electrodes are aligned, that is, in the second direction may be lower than the resolution in the first direction, and the necessary number of expensive driving ICs can be reduced.

A second liquid crystal display apparatus according to the present invention comprises: a liquid crystal layer comprising liquid crystal; a plurality of scanning electrodes aligned in a first direction at a first pitch, each of the scanning electrodes extending in a second direction substantially orthogonal to the first direction; and a plurality of signal electrodes facing the scanning electrodes with the liquid crystal layer sandwiched between the signal electrodes and the scanning electrodes, the signal electrodes being aligned in the second direction at a second pitch and each of the signal electrodes extending in the first direction, and in the apparatus, one of the first pitch and the second pitch is 1/n of the other, wherein 1<n<2.

In the second liquid crystal display apparatus, the resolution in one of the vertical direction and the horizontal direction is higher than the resolution in the other direction. Especially if the lines of pixels at a higher resolution are driven by the scanning electrodes, blackout is not remarkable, and interlace scanning can be carried out without degrading the display performance. For example, when n=1.5, original image data for two pixels can be displayed on three pixels by executing an interpolation of the original data, and in this case, it is not necessary to heighten the resolution and the capacity of an image memory. Because n is smaller than 2, the difference in resolution between the horizontal direction and the vertical direction is not so large. Therefore, fabrication of the liquid crystal display apparatus is easy.

A third liquid crystal display apparatus according to the present invention comprises: a liquid crystal layer comprising liquid crystal; a plurality of first scanning electrodes aligned in a first direction at a first pitch, each of the first scanning electrodes extending in a second direction substantially orthogonal to the first direction; a plurality of second scanning electrodes aligned in the first direction at a second pitch that is different from the first pitch, each of the second scanning electrodes extending in the second direction; and a plurality of signal electrodes facing the first and second scanning electrodes with the liquid crystal layer sandwiched between the signal electrodes and the first and second scanning electrodes, the signal electrodes being aligned in the second direction at a third pitch and each of the signal electrodes extending in the first direction.

In the third liquid crystal display apparatus, the signal electrodes may comprise first signal electrodes which are coupled with the first scanning electrodes and second signal electrode which are coupled with the second scanning electrodes.

The third liquid crystal display apparatus has a first display area which comprises the first scanning electrodes and part of the signal electrodes (first signal electrodes) and a second display area which comprises the second scanning electrodes and the other part of signal electrodes (second signal electrodes), and the first display area and the second display area are different from each other in resolution. In the display area which has a higher resolution, blackout is not remarkable, and interlace scanning can be carried out without degrading the display performance. In the display area which has a lower resolution, the pixels are comparatively large. Therefore, fabrication of the area is easy, and the cost is low.

In the third liquid crystal display apparatus, the resolution is heightened only in a part of the display, and it never happens that the frequency of a clock signal used for sending of image data may be higher. Consequently, the necessary number of expensive driving ICs is not so large, and the power consumption is not large.

In the first, second and third liquid crystal display apparatuses, the liquid crystal forming the pixels preferably has a memory effect and exhibits a cholesteric phase. By using liquid crystal of this kind, a comparatively large screen can be fabricated at low cost. Also, liquid crystal of this kind is capable of displaying an image thereon continuously after stoppage of a supply of electric power thereto, and this contributes to energy saving.

### BRIEF DESCRIPTION OF THE DRAWINGS

These and other objects and features of the present invention will be apparent from the following description with reference to the accompanying drawings, in which:

FIG. 1 is a sectional view of a liquid crystal display which is employed in a first embodiment of a liquid crystal display apparatus according to the present invention;

FIG. 2 is a block diagram which shows a driving circuit of the liquid crystal display;

FIG. 3 show a first and a second exemplary pixel structures according to the first embodiment;

FIG. 4 is a chart which shows driving waveforms in a first example of a driving method;

FIG. 5 is a chart which shows driving waveforms in a second example of the driving method;

FIG. 6 is a chart which shows a first example of interlace scanning;

FIG. 7 is a chart which shows writing on a pixel;

FIG. 8 shows original image data and a display which is made by executing the first example of interlace scanning;

FIG. 9 shows processes of writing by executing the first example of interlace scanning;

FIG. 10 shows a scroll display made by executing the first example of interlace scanning;

FIG. 11 is a chart which shows a second example of interlace scanning;

FIG. 12 shows a display of original image data shown by FIG. 8a which is made by executing the second example of interlace scanning;

FIG. 13 is a block diagram which shows a driving circuit in a second embodiment of the present invention;

FIG. 14 shows pixel structures, FIG. 14a being a chart which shows a pixel structure according to the second embodiment, FIG. 14b being a chart which shows the pixel structure of original image data and FIG. 14c being a chart which shows the pixel structure of one unit according to the second embodiment;

FIG. 15 shows a first way of allocating data to each pixel according to the second embodiment, FIG. 15a showing an original image, FIG. 15b being a chart which shows image data in a magnified part of the original image and FIG. 15c being a chart which shows a state wherein data shown by FIG. 15b are allocated for the pixel structure according to the second embodiment;

FIG. 16 shows a second way of allocating data to each pixel according to the second embodiment, FIG. 16a being a chart which shows original data; FIG. 16b being a chart which shows a state wherein the original data are allocated for the pixel structure according to the second embodiment and FIG. 16c being a chart which shows a state wherein the original data are allocated for the pixel structure according to the second embodiment by using a letter font;

FIG. 17 illustrates the principle of operation of a driving IC, FIGS. 17a, 17b and 17c being block diagrams of a shift register and FIG. 17d being a block diagram of an averaging circuit;

FIG. 18 shows driving ICs, FIG. 18a being a block diagram which shows an exemplary structure of a driving IC and FIG. 18b being a block diagram which shows a state wherein driving ICs are in cascade connection with each other;

FIG. 19 is a chart which shows a third example of interlace scanning;

FIG. 20 shows processes of writing an image by executing the third example of interlace scanning;

FIG. 21 is a chart which shows a fourth example of interlace scanning;

FIG. 22 shows processes of writing by executing the fourth example of interlace scanning;

FIG. 23 is a block diagram which shows a driving circuit according to a third embodiment;

FIG. 24 shows a first exemplary and a second exemplary pixel structure according to the third embodiment;

FIG. 25 is an illustration of a first exemplary arrangement of driving ICs;

FIG. 26 is an illustration of a second exemplary arrangement of driving ICs;

FIG. 27 is a chart which shows a fifth example of interlace scanning;

FIG. 28 shows a comparative example, FIG. 28a showing original image data and Figs, 28b and 28c showing processes of writing the image data on square pixels by executing the fifth example of interlace scanning;

FIG. 29 shows allocation of the original image data for the pixel structure according to the third embodiment and processes of writing the data by executing the fifth example of interlace scanning;

FIG. 30 is a chart which shows a sixth example of interlace scanning;

FIG. 31 is a chart which shows a seventh example of interlace scanning;

FIG. 32 shows processes of writing based on the original image data by executing the sixth example of interlace scanning;

FIG. 33 is a block diagram which shows a modification of the driving circuit of the third embodiment; and

FIG. 34 shows exemplary processes of writing still pictures and motion pictures.

### DETAILED DESCRIPTION OF THE PREFERRED EMBODIMENTS

Embodiments of a liquid crystal display apparatus according to the present invention are described with reference to the accompanying drawings.

### FIRST EMBODIMENT

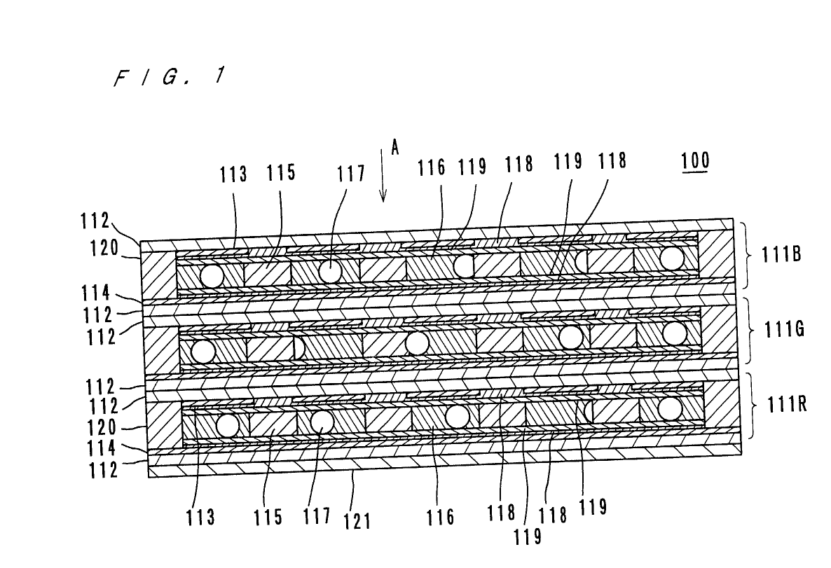

Liquid Crystal Display; See FIG. 1

First, a liquid crystal display which is used in a first embodiment is described. The liquid crystal display comprises liquid crystal which exhibits a cholesteric phase. The same liquid crystal display is used in a second embodiment and in a third embodiment which will be described later.

FIG. 1 shows a reflective type full-color liquid crystal display which is driven by a simple-matrix driving method. In this liquid crystal display 100, on a light absorbing layer 121, a red display layer 111R, a green display layer 111G and a blue display layer 111B are laminated. The red display layer 111R makes a display by switching between a red selective reflection state and a transparent state. The green display layer 111G makes a display by switching between a green selective reflection state and a transparent state. The blue display layer 111B makes a display by switching between a blue selective reflection state and a transparent state.

Each of the display layers 111R, 111G and 111B has, between transparent substrates 112 on which transparent electrodes 113 and 114 are formed, resin columnar nodules 115, liquid crystal 116 and spacers 117. On the transparent electrodes 113 and 114, an insulating layer 118 and an alignment controlling layer 119 are provided if necessary. Around the substrates 112 (out of a displaying area), a sealant 120 is provided to seal the liquid crystal 116 therein.

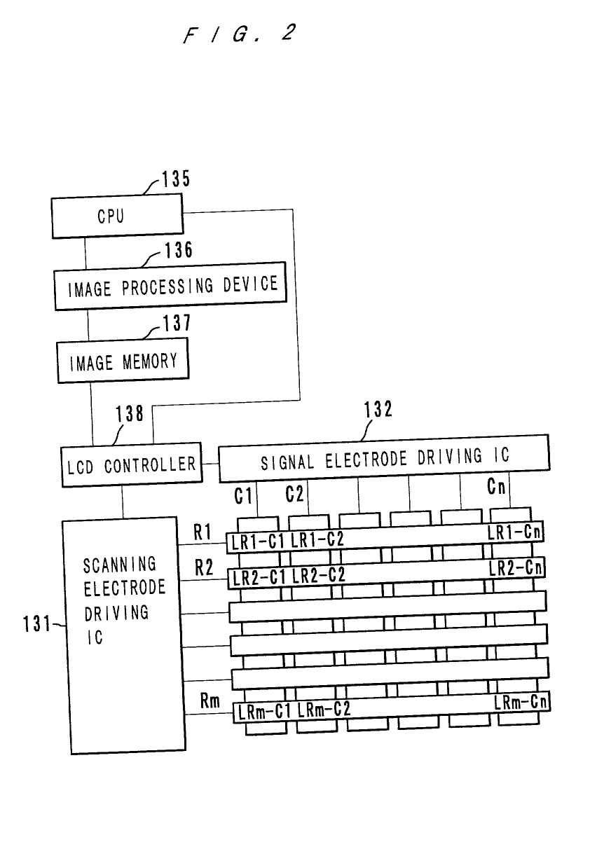

The transparent electrodes 113 and 114 are connected to driving ICs 131 and 132 respectively (see FIG. 2), and specified pulse voltages are applied between the transparent electrodes 113 and 114. In response to the voltages applied, the liquid crystal 116 switches between a transparent state to transmit visible light and a selective reflection state to selectively reflect light of a specified wavelength.

In each of the display layers 111R, 111G and 111B, the transparent electrodes 113 and 114, respectively, are composed of a plurality of strip-like electrodes which are arranged in parallel at fine intervals. The extending direction of the strip-like electrodes 113 and the extending direction of the strip-like electrodes 114 are orthogonal to each other, and the electrodes 113 and the electrodes 114 face each other. Electric power is applied between these upper electrodes and lower electrodes serially, that is, voltages are applied to the liquid crystal 116 serially in a matrix, so that the liquid crystal 116 makes a display. This is referred to as matrix driving. The intersections between the electrodes 113 and 114 function as pixels. By carrying out this matrix driving toward the respective display layers 111R, 111G and 111B, a full-color image is displayed on the liquid crystal display 100.

A liquid crystal display which has liquid crystal which exhibits a cholesteric phase between two substrates makes a display by switching the liquid crystal between a planar state and a focal-conic state. When the liquid crystal is in the planar state, the liquid crystal selectively reflects light of a wavelength λ=Pn (P: helical pitch of the cholesteric liquid crystal, n: average refractive index). When the liquid crystal display is in the focal-conic state, if the wavelength of light selectively reflected by the liquid crystal is in the infrared spectrum, the liquid crystal scatters light, and if the wavelength of light selectively reflected by the liquid crystal is shorter than the infrared spectrum, the liquid crystal transmits visible light. Accordingly, if the wavelength of light selectively reflected by the liquid crystal is set within the visible spectrum and if a light absorbing layer is provided in the side opposite the observing side of the display, the liquid crystal display makes displays as follows: when the liquid crystal is in the planar state, the liquid crystal display makes a display of the color determined by the selectively reflected light; and when the liquid crystal is in the focal-conic state, the liquid crystal display makes a display of black. Also, if the wavelength of light selectively reflected by the liquid crystal is set within the infrared spectrum and if a light absorbing layer is provided in the side opposite the observing side of the display, the liquid crystal display makes displays as follows: when the liquid crystal is in the planar state, the liquid crystal reflects infrared light but transmits visible light, and accordingly, the liquid crystal display makes a display of black; and when the liquid crystal display is in the focal-conic state, the liquid crystal scatters light, and accordingly, the liquid crystal display makes a display of white.

In the liquid crystal display 100 in which the display layers 111R, 111G and 111B are laminated, when the liquid crystal of the blue display layer 111B and the liquid crystal of the green display layer 111G are in the focal-conic state (transparent state) and when the liquid crystal of the red display layer 111R is in the planar state (selective reflection state), a display of red is made. When the liquid crystal display of the blue display layer 111B is in the focal-conic state (transparent state) and when the liquid crystal of the green display layer 111G and the liquid crystal of the red display layer 111R are in the planar state (selective reflection state), a display of yellow is made. Thus, by setting the display layers 111R, 111G and 111B in the transparent state or in the selective reflection state appropriately, displays of red, green, blue, white, cyan, magenta, yellow and black are possible. Further, by setting the display layers 111R, 111G and 111B in intermediate states, displays of intermediate colors are possible, and thus, the liquid crystal display 21 can be used as a full-color display.

The liquid crystal 116 preferably exhibits a cholesteric phase at room temperature. Especially chiral nematic liquid crystal which is produced by adding a chiral agent to nematic liquid crystal is suited.

A chiral agent is an additive which, when it is added to nematic liquid crystal, twists molecules of the nematic liquid crystal. When a chiral agent is added to nematic liquid crystal, the liquid crystal molecules form a helical structure with uniform twist intervals, and thereby, the liquid crystal exhibits a cholesteric phase.

However, the liquid crystal with a memory effect is not necessarily of this structure. It is possible to structure the liquid crystal display layer to be a conventional polymer-dispersed type composite layer in which liquid crystal is dispersed in a three-dimensional polymer net or in which a three-dimensional polymer net is formed in liquid crystal.

Driving Circuit; See FIG. 2

As FIG. 2 shows, the pixels of the liquid crystal display 100 are structured into a matrix which is composed of a plurality of scanning electrodes R1, R2, . . . Rm and a plurality of signal electrodes C1, C2, . . . Cn (n, m: natural numbers). The scanning electrodes R1, R2 . . . Rm are connected to output terminals of a scanning electrode driving IC 131, and the signal electrodes C1, C2, . . . Cn are connected to output terminals of a signal electrode driving IC 132.

The scanning electrode driving IC 131 outputs a selective signal to a specified one of the scanning electrodes R1, R2, . . . Rm while outputting a non-selective signal to the other scanning electrodes R1, RJ2, . . . Rm. The scanning electrode driving IC 131 outputs the selective signal to the scanning electrodes R1, R2, . . . Rm one by one at specified time intervals. In the meantime, the signal electrode driving IC 132 outputs signals to the signal electrodes C1, C2, . . . Cn simultaneously in accordance with image data to write the pixels on the selected scanning electrode. For example, while a scanning electrode Ra (a<m, a: natural number) is selected, the pixels LRa-C1 through LRa-Cn on the intersections of the scanning electrode Ra and the signal electrodes C1, C2, . . . Cn are written simultaneously. In each pixel, the voltage difference between the scanning electrode and the signal electrode is a voltage for writing the pixel (writing voltage), and each pixel is written in accordance with this writing voltage.

The driving circuit of the liquid crystal display 100 comprises a CPU 135, an image processing device 136, an image memory 137, an LCD controller 138, and the driving ICs (drivers) 131 and 132. In accordance with image data stored in the image memory 137, the LCD controller 138 controls the driving ICs 131 and 132. Thereby, voltages are applied between the scanning electrodes and the signal electrodes of the liquid crystal display 100 serially, so that an image is written on the liquid crystal display 100.

Suppose the threshold voltage (first threshold voltage) to untwist liquid crystal which exhibits a cholesteric phase to be Vth1, when the first threshold voltage Vth1 is applied to the liquid crystal for a sufficiently long time and thereafter, the voltage is lowered under a second threshold voltage Vth2 which is lower than Vth1, the liquid crystal comes to a planar state. When a voltage which is higher than Vth2 and lower than Vth1 is applied to the liquid crystal for a sufficiently long time, the liquid crystal comes to a focal-conic state. These two states are maintained even after stoppage of application of voltage. Also, by applying voltages between Vth1 and Vth2 to the liquid crystal, it is possible to display intermediate tones, that is, gray levels.

Further, when writing part of the liquid crystal display, only specified scanning electrodes including the part shall be selected. In this way, writing is carried out on only necessary part of the liquid crystal display, which requires a shorter time.

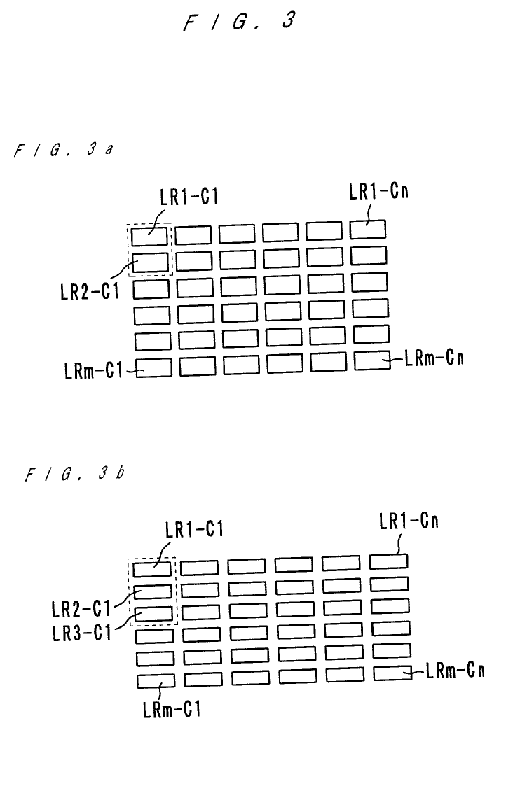

Pixel Structure; See FIG. 3

FIGS. 3a and 3b show respectively a first exemplary pixel structure and a second exemplary pixel structure of the liquid crystal display. In the first and second exemplary pixel structures, the widths of the scanning electrodes R1 through Rm are smaller than those of the signal electrodes C1 through Cn, and accordingly, the respective pixels LR1-C1 through LRm-Cn are rectangular. Consequently, the scanning electrodes extend along the longer sides of the pixels, and the signal electrodes extend in a direction substantially orthogonal to the longer sides of the pixels.

In FIGS. 3a and 3b, an area enclosed by a dotted line is an area to display image data for one pixel. In order to display image data in the first exemplary pixel structure, image data for one pixel are further resolved double in the scanning electrode aligning direction (the direction in which the scanning electrodes are aligned). For example, if the pixel density in the horizontal direction along the signal electrode aligning direction (the direction in which the signal electrodes are aligned) is 90 dpi, the pixel density in the vertical direction along the scanning electrode aligning direction is 180 dpi. In order to display image data in the second exemplary pixel structure, image data for one pixel are further resolved three times in the scanning electrode aligning direction. For example, if the pixel density in the signal electrode aligning direction is 90 dpi, the pixel density in the scanning electrode aligning direction is 270 dpi.

The density ratio of the horizontal direction to the vertical direction is determined mainly in accordance with the number of fields in carrying out interlace scanning, which will be described later. For example, in a first example of interlace scanning, one frame is divided into two fields, and accordingly, the density ratio of the horizontal direction to the vertical direction is 1:2. In a second example of interlace scanning, one frame is divided into three fields, and accordingly, the density ratio of the horizontal direction to the vertical direction is 1:3. The density ratio of the horizontal direction to the vertical direction does not always necessarily correspond to the number of fields; for example, in the first exemplary pixel structure, interlace scanning may be carried out with one frame divided into three fields; and in the second exemplary pixel structure, interlace scanning may be carried out with one frame divided into two fields.

Also, the density ratio of the horizontal direction to the vertical direction may be larger than 1:3, and the number of fields in carrying out interlace scanning may be more than 3. However, the larger the density ratio of the horizontal direction to the vertical direction, the more difficult the processing/formation of the electrodes, and the larger the number of fields, the more easily the blackout of the liquid crystal appears. Therefore, it is the most practical that the density ratio of the horizontal direction to the vertical direction is 1:2 and that the number of fields in carrying out interlace scanning is 2.

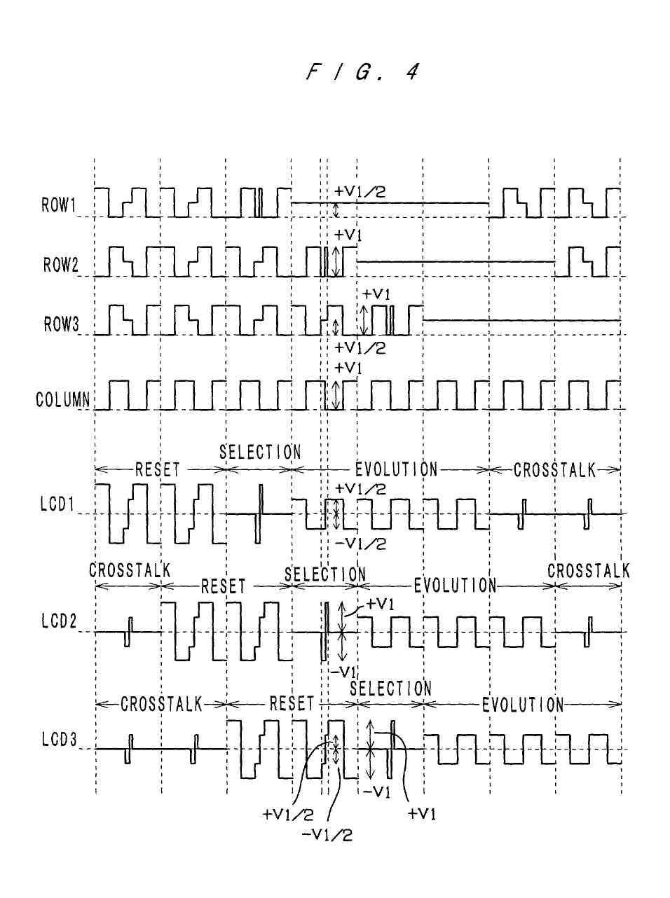

### Driving Example 1; See FIG. 4

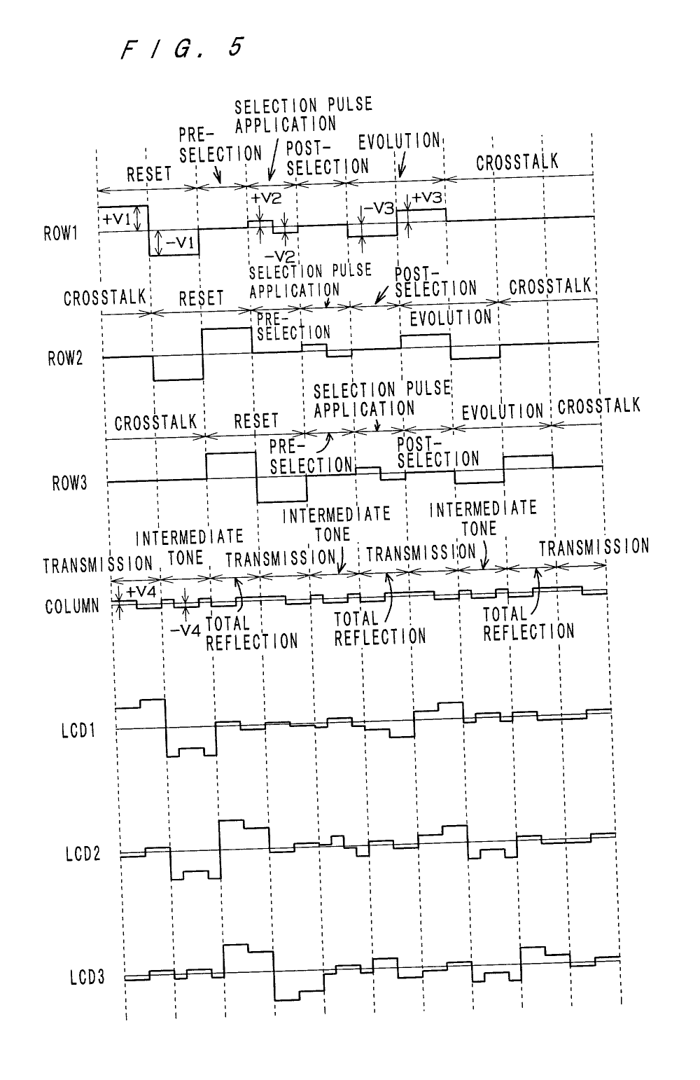

Next, a first example of the driving method is described. In FIG. 4 (also in FIG. 5), “ROW1”, “ROW2” and “ROW3” mean three scanning electrodes which are serially selected, “COLUMN” means a signal electrode which crosses the three scanning electrodes (ROWS 1-3) and “LCD1”, “LCD2” and “LCD3” mean liquid crystal rorresponding to the pixels on the intersections between the ROWS 1-3 and the COLUMN.

This first example comprises a reset step, a selection step, an evolution step and a crosstalk (display) step. In the reset step, first, a specified voltage is applied to the pixels on a scanning electrode to be subjected to writing, and thereby, the liquid crystal on the pixels is reset to a homeotropic state.

The selection step is composed of three steps (a pre-selection step, a selection pulse application step and a post-selection step). Only in a part (the selection pulse application step) of the selection step, a selection pulse in accordance with image data is applied to the liquid crystal, and substantially 0 volt is applied to the liquid crystal in the pre-selection step and in the post-selection step. The voltage and the form of the selection pulse depends on whether the pixel is desired to finally come to a planar state or to finally come to a focal-conic state. In the selection pulse application step, a selection pulse of a specified voltage is applied to the pixels on a scanning line which are desired to finally come to a planar state the liquid crystal.

In the evolution step thereafter, a specified pulse voltage is applied to all the pixels on the scanning electrode which is subjected to writing. Then, in the crosstalk step, 0 volt is applied to all the pixels. Thus, the pixels which were supplied with the selection pulse of the specified voltage come to a planar state.

On the other hand, to the pixels which are desired to finally come to a focal-conic state, substantially 0 volt is applied in the selection pulse application step.

In the evolution step thereafter, as mentioned, the specified pulse voltage is applied to all the pixels on the scanning electrode which is subjected writing. Consequently, the pixels which were supplied with substantially 0 volt in the selection pulse application step come to a focalconic state. In the crosstalk step, as mentioned, 0 volt is applied to all the pixels. The pixels in a focal-conic state, even after the voltage applied thereto becomes 0 volt, stay in the same state.

Thus, the final state of the liquid crystal can be selected depending on the selection pulse applied to the liquid crystal in the middle short period of the selection step, that is, in the selection pulse application step. Also, by adjusting the pulse width of the selection pulse, and more specifically, by changing the form of the pulse applied to the signal electrodes in accordance with image data, intermediate tones can be displayed.

The form of the selection pulse must be changed according to image data to be written on the pixel, and selection pulses of different forms in accordance with image data must be applied to the column. On the other hand, at the pre-selection step and at the post-selection step of every pixel, the voltage applied thereto is zero, and a combination of specified pulse waveforms to be applied to the rows and the columns to cause application of 0 volt to the pixels can be used. In the first example shown by FIG. 4, by using this, reset, evolution and display are carried out simultaneously on the pixels on a plurality of scanning electrodes.

For example, while the LCD 2 is in the pre-selection step, pulses of a voltage +V1 which are out of phase with each other are applied to the ROW2 and ROW3, and a voltage +V½ is applied to the ROW1. At this time, if a pulse of +V1 which is out of phase with the pulse applied to the ROW3 is applied to the COLUMN, a reset pulse of ±VR=±V1 is applied to the LCD3, 0 volt is applied to the LCD2, and an evolution pulse ±Ve=±V½ is applied to the LCD1.

While the LCD2 is in the selection pulse application step, a data pulse of a form in accordance with image data (of a voltage +V1) is applied to the COLUMN. Accordingly, a voltage of +V½ is applied to the ROW1 and the ROW2 so that a voltage of ±V½ can be applied to the LCD1 and the LCD3. A pulse of a voltage +V1 is applied to the ROW2, so that the voltage difference (±V1 or 0) between the voltage applied to the ROW2 and the data pulse applied to the COLUMN is applied to the LCD2 as a selection pulse of a voltage ±Vse1. By changing the form of the data pulse applied to the COLUMN, the pulse width of the selection pulse can be changed.

In the post-selection step, the same process as in the preselection step is carried out. Specifically, pulses which are of a voltage +V1 but are out of phase are applied to the ROW2 and the ROW3, and a pulse of a voltage +V½ is applied to the ROW1. At this time, a pulse of a voltage +V1 which is out of phase with the pulse applied to the ROW3 is applied to the COLUMN. Thereby, a reset pulse of ±Vr=±V1 is applied to the LCD3, 0 volt is applied to the LCD2, and an evolution pulse ±Ve=±V½ is applied to the LCD1.

In the steps other than the reset step, the selection step and the evolution step, pulses in phase with the data pulses applied to the signal electrode in the pre-selection step and in the post-selection step are applied, and while any of the other scanning electrodes is in the selection pulse application step, a pulse of a voltage +V½ is applied. Thereby, to the part of the liquid crystal corresponding to this pixel, a crosstalk voltage ±V½ with the same pulse width as that of the selection pulse is applied. The pulse width of this crosstalk voltage is too narrow to change the state of the liquid crystal.

By applying the above-described pulses to the scan electrodes repeatedly, an image is displayed on the liquid crystal display. The selection of the scan electrodes may be performed by interlace scanning or by sequential scanning. Also, because it is possible to apply the reset pulse, the selection pulse and the evolution pulse to any desired scanning electrodes, partial writing of the liquid crystal display is possible.

### Driving Example 2; See FIG. 5

Next, a second example of the driving method is described. Here, to the signal electrode, a signal to select “transmission”, “intermediate tone” and “total reflection” in order is inputted.

In FIG. 5, for simplification, the reset step and the evolution step have a length twice the selection step; actually, however, the length of the reset step and the length of the evolution step are desired to be sufficiently long to reset the liquid crystal and to stable the liquid crystal into the selected state. Ordinarily, the length of the reset step and the length of the evolution step are sufficiently long compared with the length of the selection step or the selection pulse width, for example, are tens of times the length of the selection step or the selection pulse width.

In the second example, the selection step is composed of a selection pulse application step, and a pre-selection step and a post-selection step which are before and after the selection pulse application step. The pre-selection step and the post-selection step have a length which is a multiple of the pulse width of a selection pulse (the application time of a selection pulse). In FIG. 5, the length of the pre-selection step and the post-selection step is equal to the pulse width of a selection pulse.

To the ROW1, the ROW2 and the ROW3, a reset voltage ±V1, a selection voltage ±V2 and an evolution voltage ±V3 are applied respectively in the reset step, in the selection step and in the evolution step. The reset step and the evolution step have a length which is a multiple (in FIG. 5, twice) of the application time of a selection pulse. In the display (crosstalk) step, 0 volt is applied. In the meantime, to the signal electrode (COLUMN), a pulse waveform which is of a voltage ±V4 and has a phase in accordance with image data is applied.

In the second example, the form of the selection pulse applied to each pixel depends on the phase and the value of the voltage ±V4 applied to the COLUMN and the selection voltage ±V2. When the voltage ±V4 is in phase with the voltage ±V2, a selection pulse of a voltage ±(V2−V4) is applied to the pixel to select a transparent (focal-conic) state. When the voltage ±V4 is completely out of phase with the voltage +V2, a selection pulse of a voltage ±(V2+V4) is applied to the pixel to select a selective reflection (planar) state. The voltages V2 and V4 are optimal values to select a transparent state and a reflection state. The voltage V4 which acts as crosstalk is a value under the threshold to change the state of the liquid crystal.

In the second example, the lines are scanned at intervals of the application time of a selection pulse, that is, the scanning time is equal to the application time of a selection pulse. Thus, in the second example, the time for scanning a screen is shorter, that is, the scanning speed is higher, compared with the first example.

Interlace Scanning

In the following, a driving method according to interlace scanning is described referring to examples 1 and 2. Interlace scanning, in contrast with sequential scanning, is to scan every two or more lines in writing one frame.

### Scanning Example 1; See FIGS. 6-10

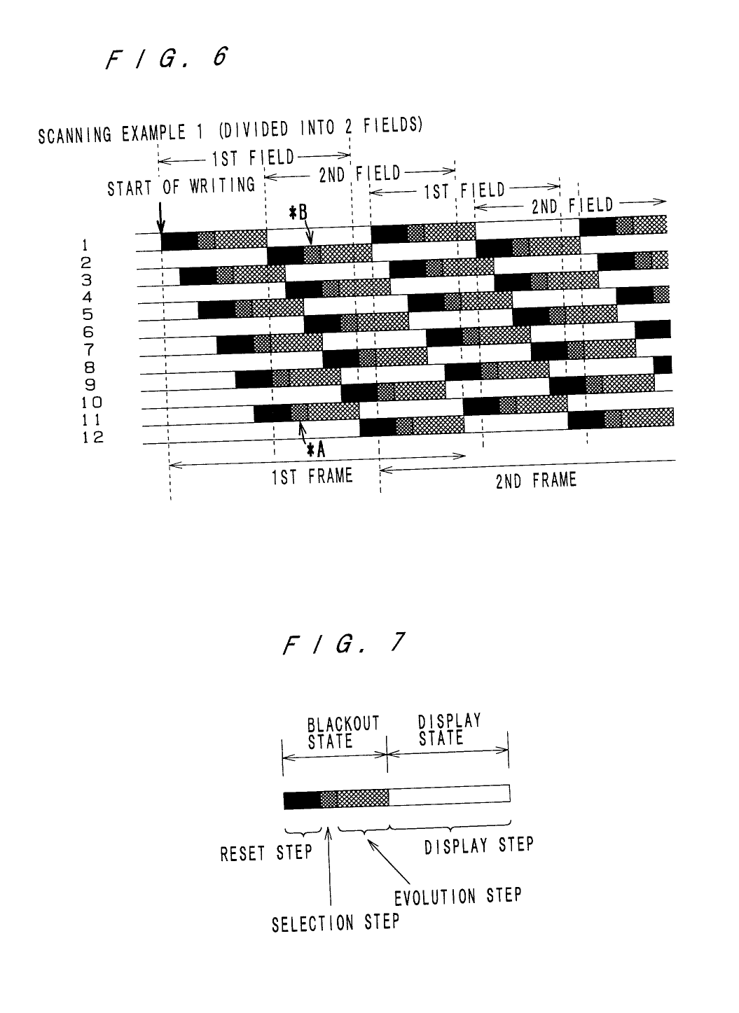

In the first example of interlace scanning, one frame is divided into two fields. In the first field, scanning lines of odd numbers are subjected to writing, and next, in the second field, scanning lines of even numbers are subjected to writing. In this way, an image of one frame is written. As FIG. 7 shows, writing on each scanning line comprises a reset step, a selection step and an evolution step, and during these three steps, the liquid crystal display is in a blackout state in which the observer sees the light absorbing layer on the backside. Thereafter, the liquid crystal comes to a display state.

Further, in a case of matrix driving, even after writing of a scanning line is completed, the scanning line is influenced by the pulses applied to the signal electrodes for writing on other scanning lines. These pulses are crosstalk pulses, and during the display step shown in FIG. 7, actually, crosstalk pulses are applied.

Depending on the kind of liquid crystal, it is probable that an image is not displayed thereon immediately after the evolution step. In this case, the delay from the end of the evolution step to the appearance of the image is expected beforehand, and this delay time is considered in actually driving the liquid crystal display.

In the first scanning example, writing on each scanning line (reset, selection and evolution) is started at uniform intervals, and based on the completion of the reset step of the last scanning line in a field, the start timing of writing on the first scanning line in the next field is determined. Referring to FIG. 6, on condition that the selection step *A of the last scanning line in the first field does not overlap with the selection step *B of the first scanning line in the second field, writing in the first field and writing in the second field overlap with each other.

As FIG. 6 shows, if each scanning line switches between a blackout state and a display state alternately and repeatedly at uniform time intervals, the whole frame is seen as an image with even brightness, that is, a flicker can be prevented. For this purpose, if the number of scanning lines in the area to be written is not so large compared with the time length of the blackout state of each scanning line, when the blackout of the first scanning line in a field ends, writing in the next field is started. If the number of scanning lines in the area to be written is large compared with the time length of the blackout of each scanning line, the length of the evolution step in the first field may be adjusted. The adjustment of the length of the evolution step will be described in connection with a second example.

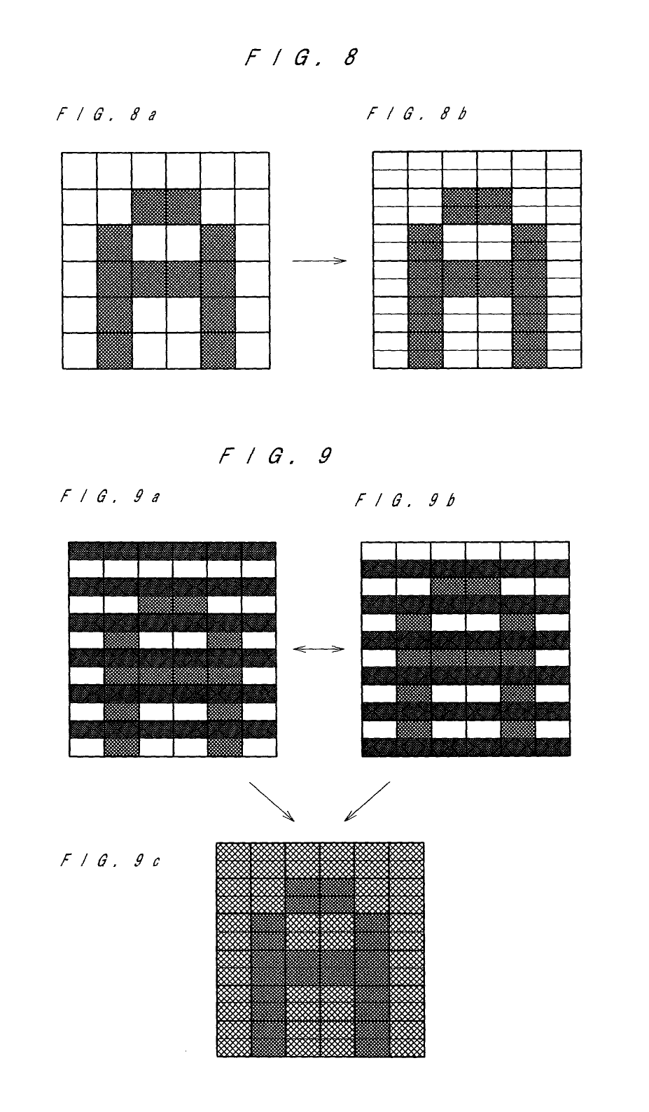

FIG. 8a shows an original image data, and FIG. 8b shows a display which is made by allocating the data to the respective pixels and by carrying out the first exemplary interlace scanning.

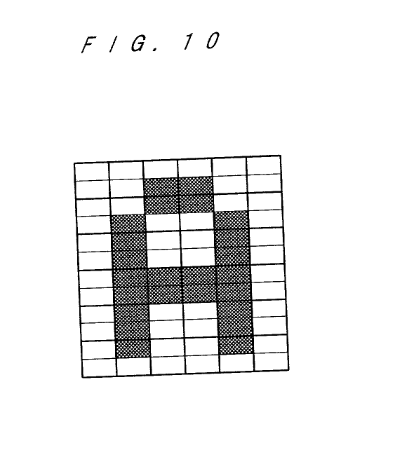

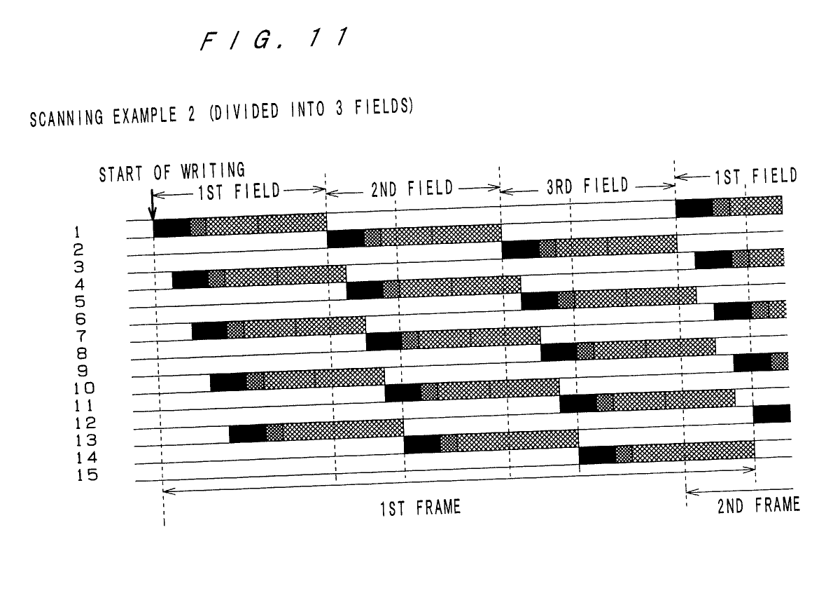

FIG. 9 shows processes of writing an image by carrying out the first exemplary interlace scanning. FIG. 9a shows a state of carrying out writing in the odd-number field, and FIG. 9b shows a state of carrying out writing in the even-number field. For example, if the length of the selection step is 0.1 ms to 0.5 ms, and if the length of the reset step and the length of the evolution step are around 25 msec, writing can be carried out at a rate of about 10 frames per second, although the rate also depends on the number of scanning lines. Accordingly, as FIG. 9c shows, the observer sees no blackouts on the screen.

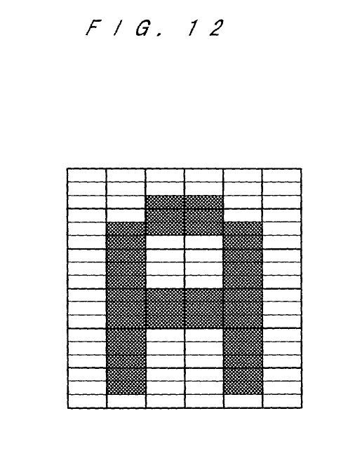

In the first exemplary interlace scanning, because the resolution of the scanning lines is high, the original image data shown by FIG. 8a can be reproduced on the screen displaced downward by one scanning line as shown by FIG. 10. Therefore, a scroll display along the signal electrode aligning direction (vertical direction) can be made smoothly. This advantage is also in a second example of interlace scanning which will be described below.

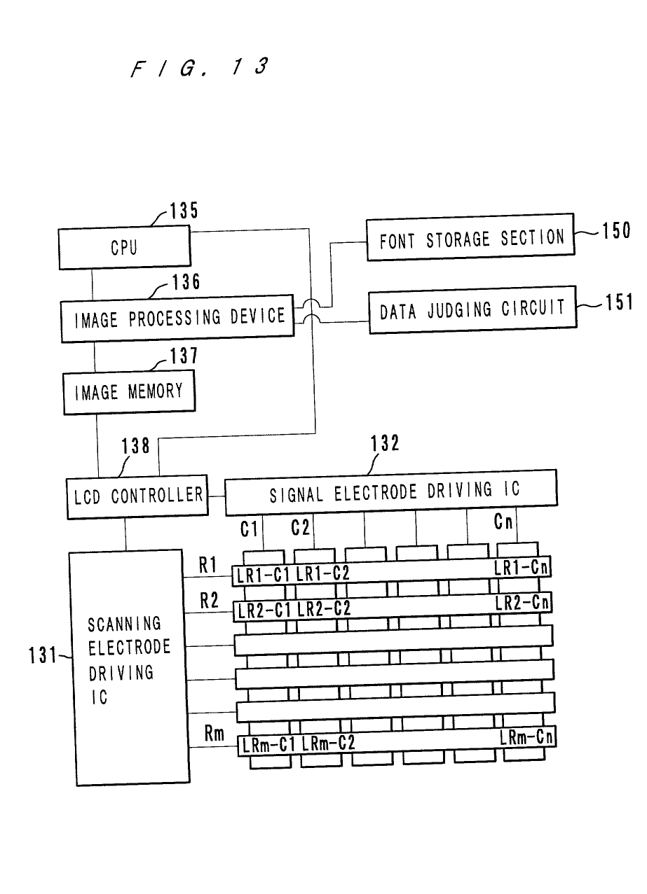

### Scanning Example 2; See FIGS. 11 and 12

This second example, like the first example, is mainly to avoid a flicker. One frame is divided into three fields, and the evolution step of each scanning line in a field is extended to the start of writing on each scanning line in the next field. With this extension, the ratio of the pixels in a blackout state to the pixels in a display state is almost constant, and the brightness of the screen is almost constant.

FIG. 12 shows a display which is made by carrying out this second exemplary interlace scanning. The original image data are shown by FIG. 8a. The resolution of the scanning lines is higher than that of the first example, and an image with a higher resolution and a higher smoothness can be displayed.

### SECOND EMBODIMENT

Next, a liquid crystal display apparatus which is a second embodiment of the present invention is described. The liquid crystal display used in the second embodiment is the same as the full-color liquid crystal display 100 shown by FIG. 1.

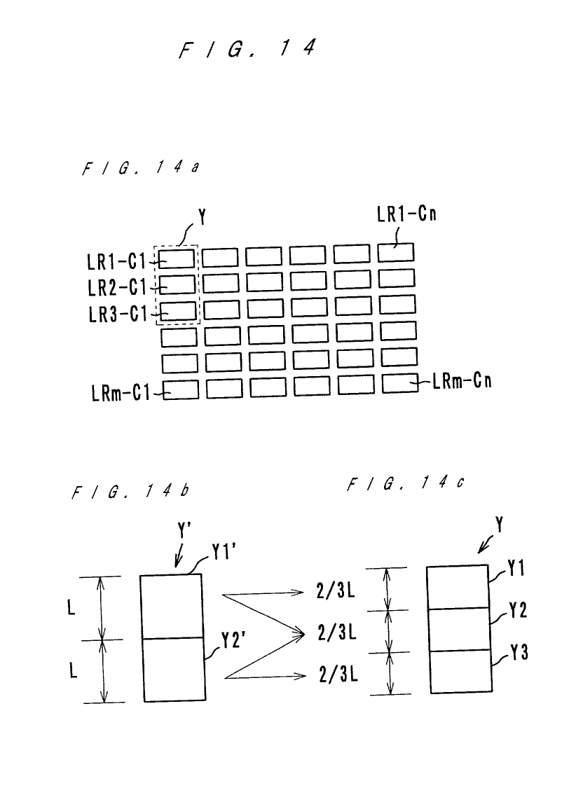

Driving Circuit; See FIG. 13

The driving circuit of the second embodiment is basically of the same structure as the driving circuit shown by FIG. 2. What is different from the driving circuit shown by FIG. 2 is that a font storage section 150 and a data judging circuit 151 are connected to the image processing device 136. The font storage section 150 is stored with an exclusive font which is prepared in consideration for the pixel structure of the liquid crystal display, and the data judging circuit 151 is to judge the kind of data to be displayed. In FIG. 13, the same elements are provided with the same reference symbols as in FIG. 2.

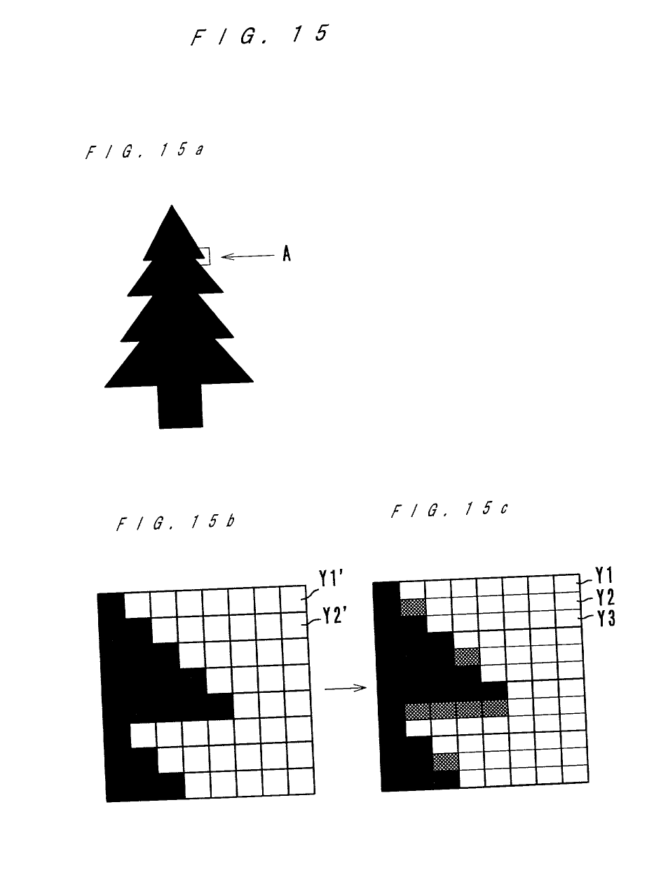

Pixel Structure; See FIG. 14

FIG. 14 shows the pixel structure of the second embodiment. In the pixel structure, as FIG. 14a shows, the widths of the scanning electrodes R1 through Rm are smaller than the widths of the signal electrodes C1 through Cn, and accordingly, the respective pixels LR1-C1 through LRm-Cn are rectangular. The scanning electrodes extend along the longer sides of the pixels, and the signal electrodes extend in a direction substantially orthogonal to the longer sides of the pixels.

The number of pixels per a unit length in the vertical direction is n times (1<n<2) the number of pixels per the unit length in the horizontal direction, that is, the dot pitch in the vertical direction is n times the dot pitch in the horizontal direction. On the contrary, the dot pitch in the horizontal direction is 1/n of the dot pitch in the vertical direction. In the second embodiment, n=1.5. Therefore, if the pixel density in the horizontal direction (the signal electrode aligning direction) is 100 dpi, the pixel density in the vertical direction (the scanning electrode aligning direction) is 150 dpi.

In this pixel structure, as FIG. 14a shows, three adjacent pixels in the vertical direction are referred to as a pixel unit Y. The pixel unit Y, which is composed of an upper pixel Y1, a middle pixel Y2 and a lower pixel Y3 (see FIG. 14c), is to display original image data in a pixel unit Y′ composed of two pixels Y1′ and Y2′ (see FIG. 14b).

The density ratio of the horizontal direction to the vertical direction shall be determined basically depending on original image data in how many pixels are to be displayed on how many pixels. In the second embodiment, original image data in two pixels are displayed on three pixels, and accordingly, the density ratio of the horizontal direction to the vertical direction is 1:1.5. In other words, if the vertical dimension of one pixel of the original image is L, the vertical dimension of one pixel of the liquid crystal display is ⅔L. The number of pixels of the display data is 1.5 times the number of pixels of the original image data, and the pixel pitch of the display data is ⅔ of the original image data.

As will be described later, n=1.5 is the most practical because pixel interpolations in this case are easy. However, the pixel density ratio and the dot pitch ratio of original image data to display data are not necessarily limited to this example and may be modified in various ways. For example, a structure to reproduce image data in three pixels on four pixels is possible.

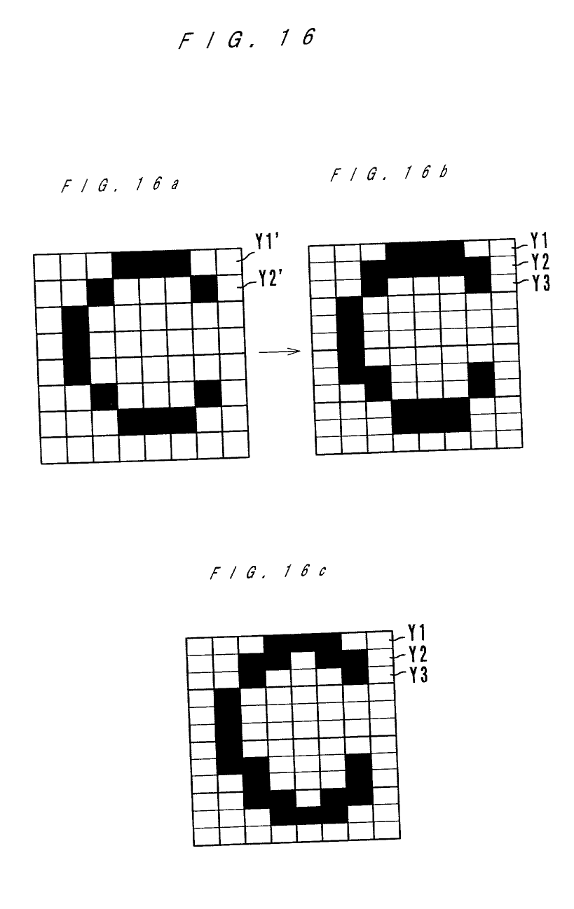

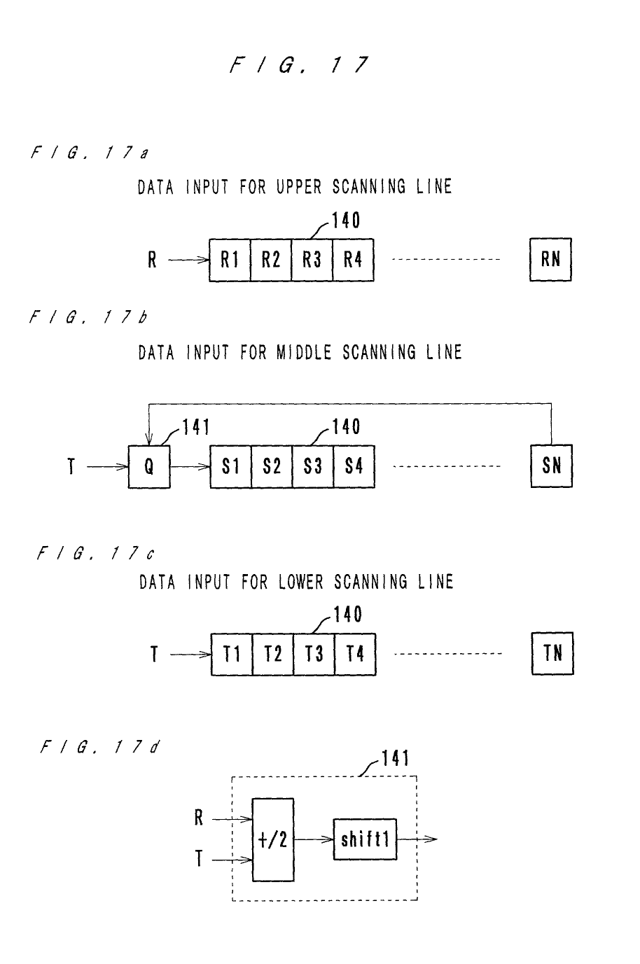

Display Data; See FIGS. 15 and 16

Next, display methods, that is, methods of allocating image data to each pixel unit Y are described. When an image as shown by FIG. 15a is to be displayed, a first display method is adopted. FIG. 15b is a magnified view of the part A of the image shown by FIG. 15a and shows image data in this part A. The image data are allocated to the pixels in the way shown by FIG. 15c. In each pixel unit Y, data in the original pixels Y1′ and Y2′ are allocated to the upper and the lower pixels Y1 and Y3 respectively. For the middle pixel Y2, display data with an average density of the densities of the pixels Y1 and Y3 are newly produced and allocated. This first display method is suited when original data are pictorial data.

FIG. 16 shows a second display method. In the second method, data in the original pixel Y1′ and data in the original pixel Y2′ are displayed in the pixel Y1 and in the pixel Y3 respectively, and the data with a higher density of the data in the pixel Y1 and the data in the pixel Y3 are displayed in the middle pixel Y2. FIG. 16a shows original data, and FIG. 16b shows a display which is made by allocating the original data to the pixels by the second method. This second display method is suited when original data are text data.

Further, a font may be prepared for a display of text data. As FIG. 16b shows, when text data are displayed by the second display method, there may be letters which are displayed in wholly black. In order to avoid this trouble, by using the letter font for a display of text data, as FIG. 16c shows, a smooth display of letters becomes possible.

In the display apparatus of the second embodiment, when the data judging circuit 151 judges that data to be displayed are pictorial data, the LCD controller 138 controls the driving ICs to display the data by the first display method.

On the other hand, when the data judging circuit 151 judges that data to be displayed are text data, the LCD controller 138 controls the driving ICs (1) to display the data by the second display method or (2) to display the data using the font stored in the font storage section 150. Whether to adopt (1) or (2) shall be determined depending on the user's taste, etc. Also, the selection between (1) and (2) may be possible by the user himself/herself.

Further, it may be possible to select a mode in which the first display method or the second display method can be selected with respect to every kind of display data.

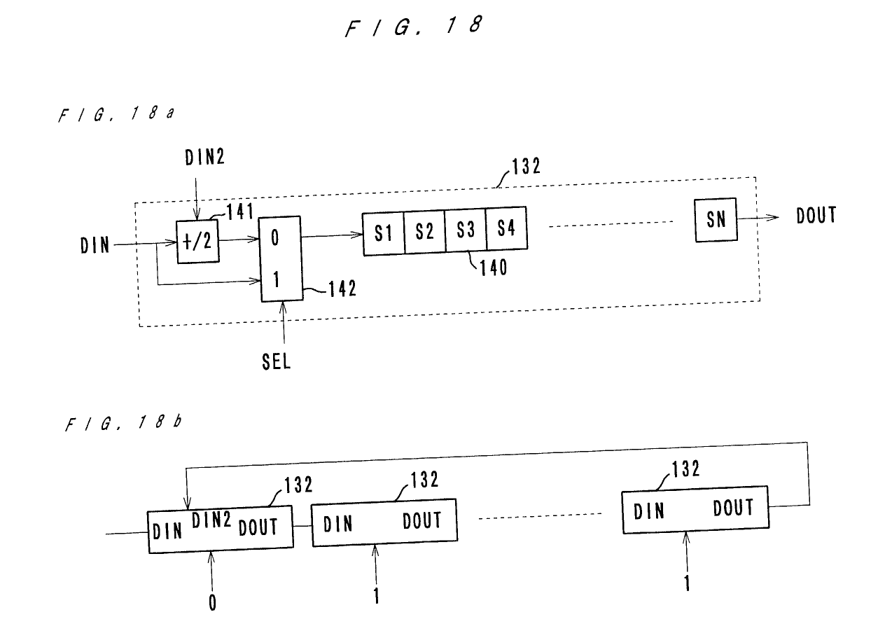

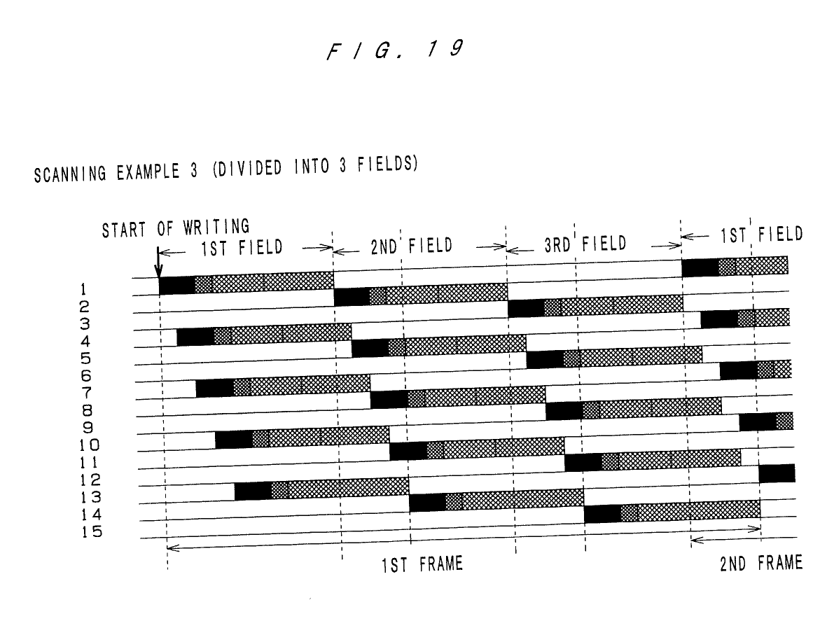

Operation and Structure of Driving ICs; See FIGS. 17 and 18

FIG. 17 shows the principle of operation of the signal electrode driving IC 132 when the first display method is carried out.

When driving the pixels on an upper scanning line, as FIG. 17a shows, data RN through R1 for the upper scanning line are inputted serially to a shift register 140 in the signal electrode driving IC 132. When all the data have been inputted, voltages are applied to the signal electrodes in accordance with the respective pieces of data.

When driving the pixels in a middle scanning line, data TN through Ti for a lower scanning line are inputted serially to the shift register 140. In the meantime, for the respective address of the shift register 140, the averages between the previously inputted data RN through R1 and the data TN through T1 are figured out, and as FIG. 17b shows, the thus figured out averages are inputted as data SN through S1. FIG. 17d shows the structure of an averaging circuit 141.

When driving the pixels on a lower scanning line, as FIG. 17c shows, the data TN through T1 for the lower scanning line are inputted serially to the shift register 140.

FIG. 18a shows the structure of the driving IC 132 to carry out the above-described operation. The driving IC 132 comprises, in addition to the shift register 140 and the averaging circuit 141, a selector circuit 142 for turning on and off the averaging circuit 141. FIG. 18b shows a state in which a plurality of driving ICs 132 are in cascade connection with each other to work as a single IC. In this case, the averaging circuits of the driving ICs 132 are controlled as follows: in driving the pixels on the upper scanning line and in driving the pixels on the lower scanning line, the averaging circuits of all the driving ICs 132 are turned off; and in driving the pixels on the middle scanning line, the averaging circuit of only the first driving IC 132 is turned on by the selector circuit 142 while all the other averaging circuits are off.

### Driving Example

In the second embodiment, the first and second driving examples (see FIGS. 4 and 5) which were described in connection with the first embodiment can be adopted.

Interlace Scanning

In the following, driving methods by interlace scanning which are adoptable in the second embodiment are described referring to scanning examples 3 and 4.

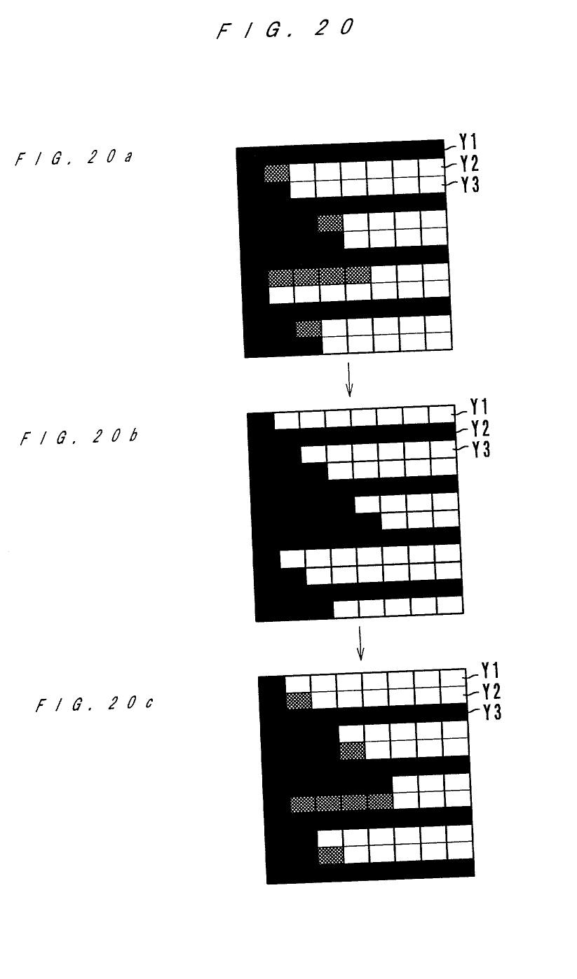

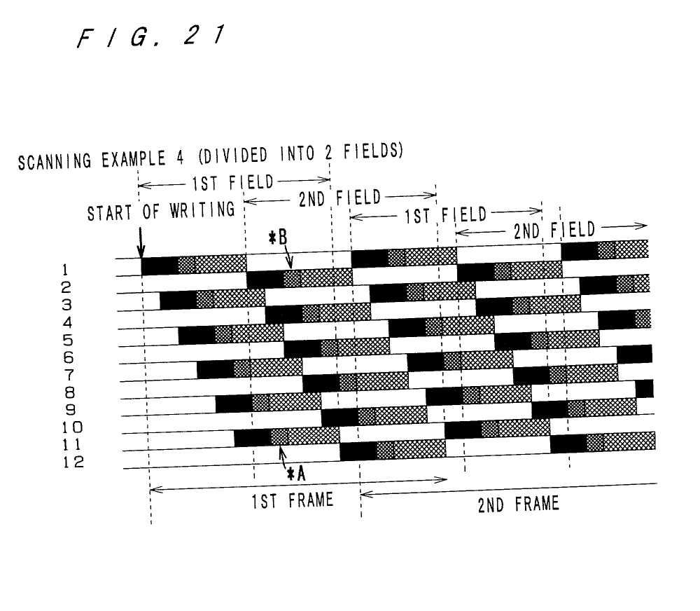

### Scanning Example 3; See FIGS. 19 and 20

In the third scanning example, one frame is divided into three fields, namely, a first field, a second field and a third field, and writing is carried out serially on scanning lines in the first field, on scanning lines in the second field and on scanning lines in the third field in this order. This third scanning example is carried out in the same way as the second scanning example shown by FIG. 11, and the detailed description is omitted.

FIG. 20 illustrates processes of writing the image shown by FIG. 15c by executing the third scanning example. FIG. 20a shows a state in which writing is carried out in the first field; FIG. 20b shows a state in which writing is carried out in the second field; and FIG. 20c shows a state in which writing is carried out in the third field.

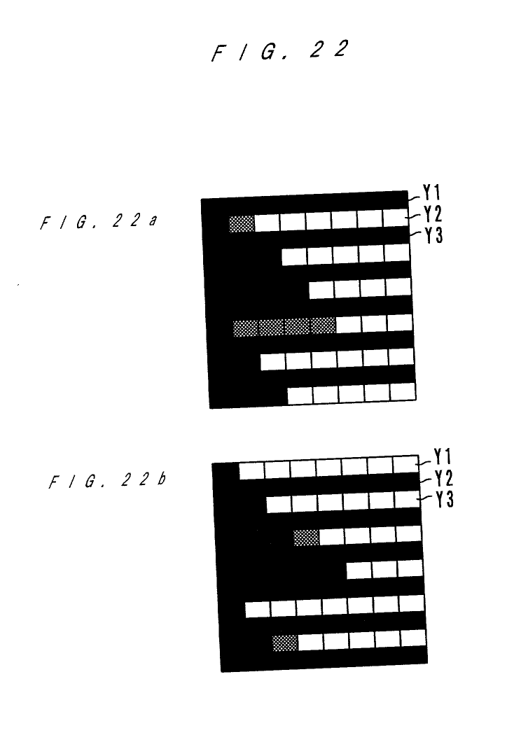

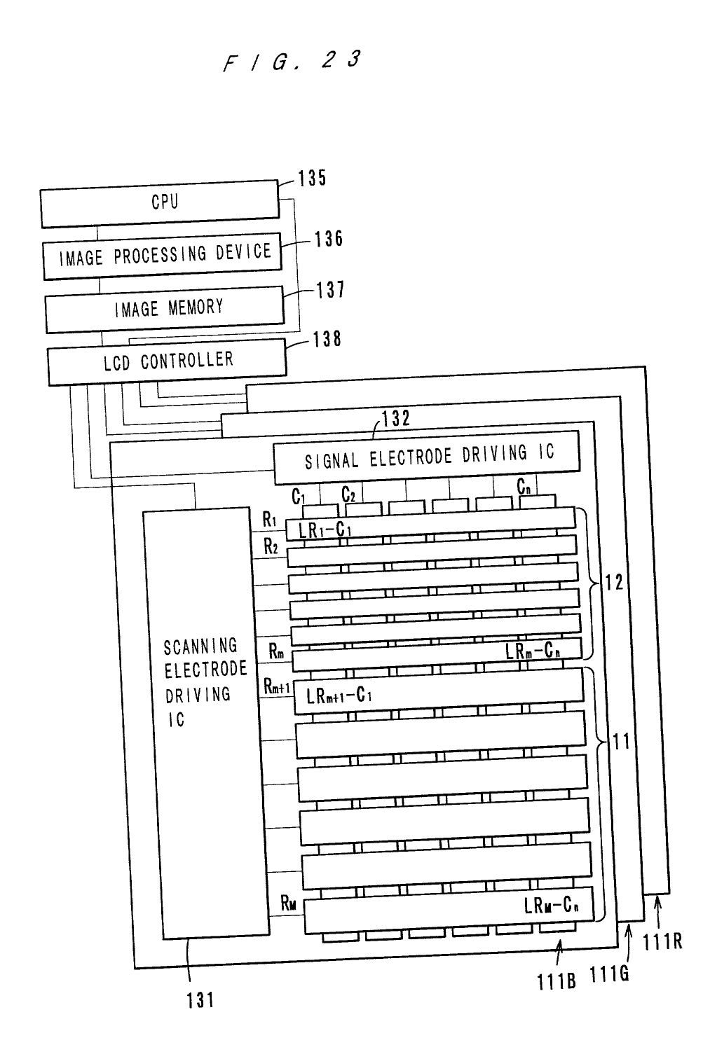

### Scanning Example 4; See FIGS. 21 and 22

In the fourth scanning example, one frame is divided into two fields, namely, an odd-number field and an even-number field. First, writing is carried out on scanning lines in the odd-number field, and next, writing is carried out on scanning lines in the even-number field. This fourth scanning example is carried out in the same way as the first example shown by FIG. 6, and the detailed description is omitted.

FIG. 22 illustrates processes of writing the image shown by FIG. 15c by executing the fourth scanning example. FIG. 22a shows a state in which writing is carried out in the odd-number field; and FIG. 22b shows a state in which writing is carried out in the even-number field.

### Third Embodiment

Next, a liquid crystal display apparatus according to the third embodiment is described. The liquid crystal display employed in the third embodiment is of the same structure as the full-color liquid crystal display 100 shown by FIG. 1.

Driving Circuit; See FIG. 23

The pixels of the liquid crystal display used in the third embodiment are, as shown in FIG. 23, structured into a matrix which is composed of a plurality of scanning electrodes R₁, through Rₘ, Rₘ₊₁ through R_{M} and a plurality of signal electrodes C₁ through Cₙ (m, n: natural number, m<M). The scanning electrodes are connected to output terminals of a scanning electrode driving IC 131, and the signal electrodes are connected to output terminals of a signal electrode driving IC 132.

The intersection between a scanning electrode and a signal electrode is defined as a pixel. The scanning electrodes Rₘ₊₁. through R_{M} form a first display area 11 which is used exclusive to display still pictures, and the first display area 11 is composed of pixels LRₘ₊₁-C₁ through LR_{M}-Cₙ. The scanning electrodes R₁ through Rₘ form a second display area 12 which is used exclusively to display motion pictures, and the second display area 12 is composed of pixels LR₁-C₁ through LRₘ-Cₙ.

In the first display area 11, the widths of the scanning electrodes Rₘ₊₁ through R_{M} are almost equal to those of the signal electrodes C₁ through Cₙ, and the pitch of the scanning electrodes Rₘ₊₁ through R_{M} are almost equal to that of the signal electrodes C₁ through Cₙ. Accordingly, the pixels LRₘ₊₁-C₁ through LR_{M}-Cₙ are substantially squares. In the second display area 12, the widths of the scanning electrodes R₁ through Rₘ are approximately a half of those of the scanning electrodes Rₘ₊₁ through R_{M}, and the pitch of the scanning electrodes R₁ through Rₘ is approximately a half of that of the scanning electrodes Rₘ₊₁ through R_{M}. Accordingly, the pixels LR₁-C₁ through LRₘ-Cₙ are rectangles of which longer sides extend horizontally.

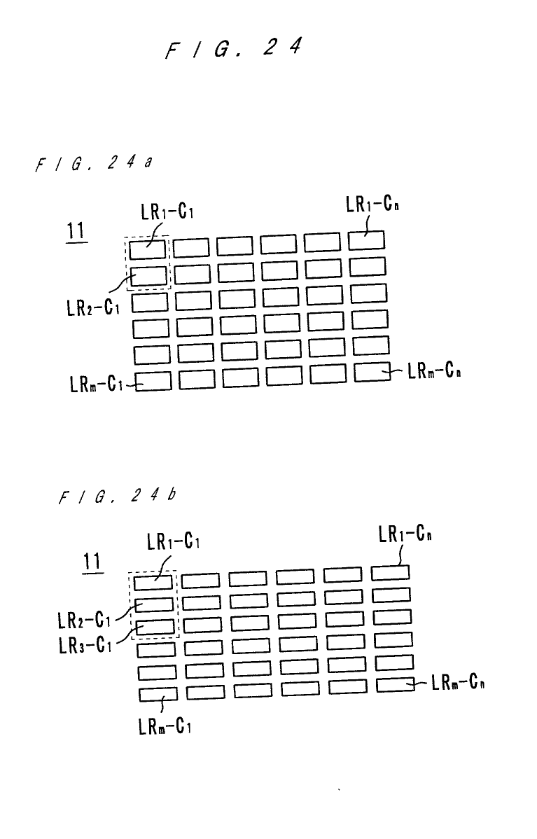

The width ratio or the pitch ratio of the scanning electrodes in the second display area 12 to the scanning electrodes in the first display area 11 is not necessarily 1:2. For example, the ratio may be 1:3 (see FIG. 24b).

FIG. 23 shows the pixel structure of the blue display layer 111B; the other display layers 111G and 111R have the same pixel structure. Usually, the driving ICs 131 and 132 are provided for the display layers 111B, 111G and 111R separately; however, it is possible to provide a single scanning electrode driving IC 131 for all the display layers.

The driving circuit shown by FIG. 23 is basically of the same structure as the driving circuit shown by FIG. 2, and a repetitious description is avoided.

Pixel Structure; See FIG. 24

FIGS. 24a and 24b show a first exemplary pixel structure and a second exemplary pixel structure of the second display area 12, which is used exclusively to display motion pictures. In both the first example and the second example, the widths of the scanning electrodes R₁ through Rₘ are smaller than those of the signal electrodes C₁ through Cₙ, and accordingly, the pixels LR₁-C₁ through LRₘ-Cₙ are rectangles of which longer sides extend horizontally.

Image data for one pixel are displayed in each of the areas enclosed by the dotted lines in FIGS. 24a and 24b. In the first example, image data for one pixel are further divided into two in the scanning electrode aligning direction. For example, if the pixels density in the signal electrode aligning direction (horizontal direction) is 90 dpi, the pixel density in the scanning electrode aligning direction (vertical direction) is 180 dpi. In the second example, image data for one pixel are further divided into three in the scanning electrode aligning direction. For example, if the pixel density in the signal electrode aligning direction is 90 dpi, the pixel density in the scanning electrode aligning direction is 270 dpi.

The density ratio of the horizontal direction to the vertical direction is determined basically depending on the number of fields in performing interlace scanning. For example, in the fifth interlace scanning example, since one frame is divided into two fields, the density ratio of the horizontal direction to the vertical direction is 1:2. In the sixth interlace scanning example, since one frame is divided into three fields, the density ratio of the horizontal direction to the vertical direction is 1:3. However, it is not always necessary to determine the density ratio of the horizontal direction to the vertical direction in accordance with the number of fields in performing interlace scanning. For example, in the first exemplary pixel structure, it is possible to perform interlace scanning by dividing one frame into three fields, and in the second exemplary pixel structure, it is possible to perform interlace scanning by dividing one frame into two fields.

Also, the density ratio of the horizontal direction to the vertical direction may be larger than 1:3, and the number of fields in carrying out interlace scanning may be more than 3. However, the larger the density ratio of the horizontal direction to the vertical direction, the more difficult the processing/formation of the electrodes, and the larger the number of fields, the more easily the blackout of the liquid crystal appears. Therefore, it is the most practical that the density ratio of the horizontal direction to the vertical direction is 1:2 and that the number of fields in carrying out interlace scanning is 2.

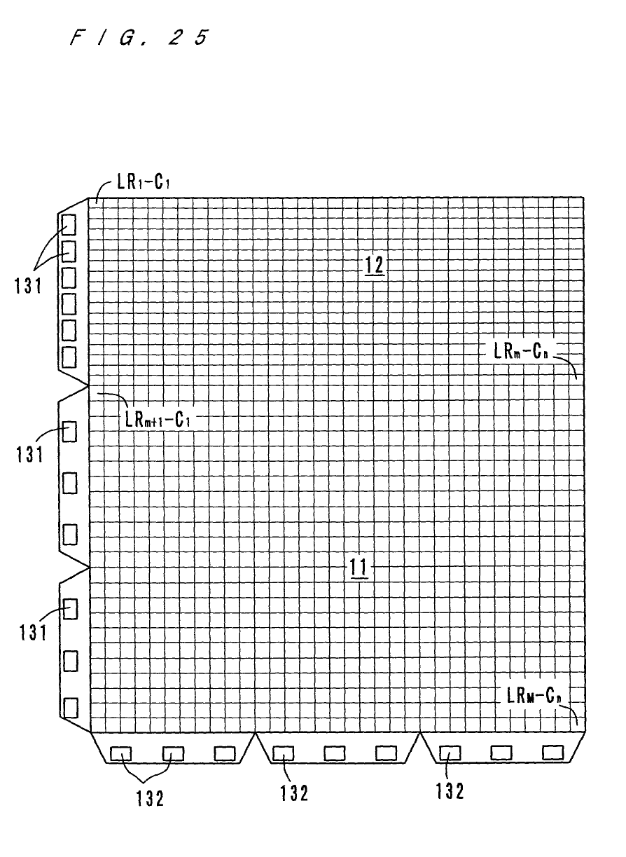

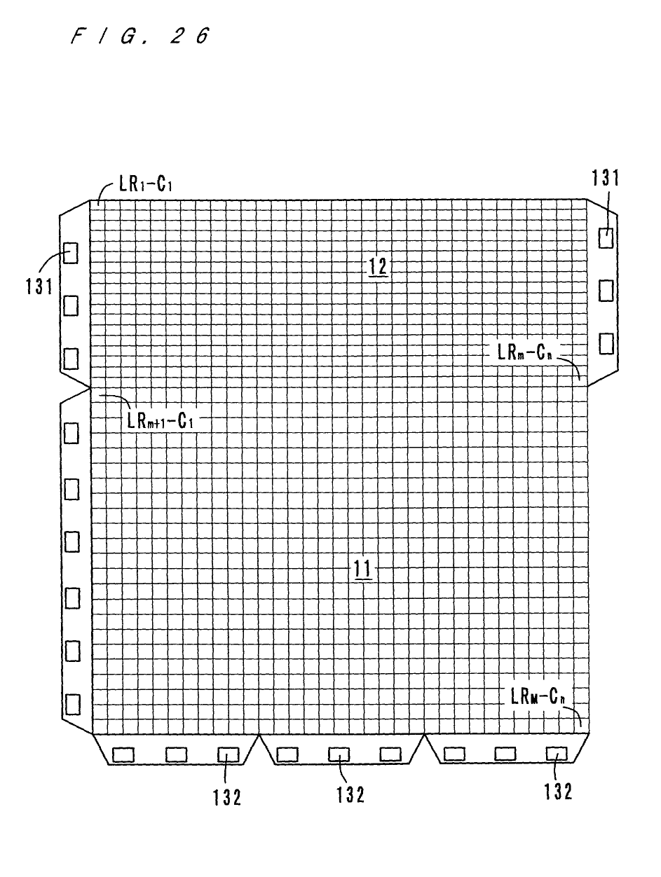

Arrangement of Driving ICs; See FIGS. 25 and 26

A plurality of scanning electrode driving ICs, each of which is to drive a plurality of scanning electrodes, may be provided, and A plurality of signal electrode driving ICs, each of which is to drive a plurality of signal electrodes, may be provided. FIG. 25 shows a first exemplary arrangement of the driving ICs, and FIG. 26 shows a second exemplary arrangement of the driving ICs. In the first example, all the scanning electrode driving ICs are arranged at one side of the display areas 11 and 12. In the second example, for the second display area 12 in which the scanning electrodes are aligned at a smaller pitch, the scanning electrode driving ICs 131 are arranged at both sides. For example, the scanning electrode driving ICs 131 for driving the scanning lines of even numbers are arranged at the right side, and the scanning electrode driving ICs 131 for driving the scanning lines of odd numbers are arranged at the left side. When the liquid crystal display is of a small size, only one scanning electrode driving IC 131 and one signal electrode driving IC 132 may be provided.

### DRIVING EXAMPLE

In the third embodiment, the first and second driving examples (see FIGS. 4 and 5) which were described in connection with the first embodiment can be adopted.

Interlace Scanning

In the following, driving methods by interlace scanning which are adoptable in the third embodiment are described referring to scanning examples 5, 6 and 7.

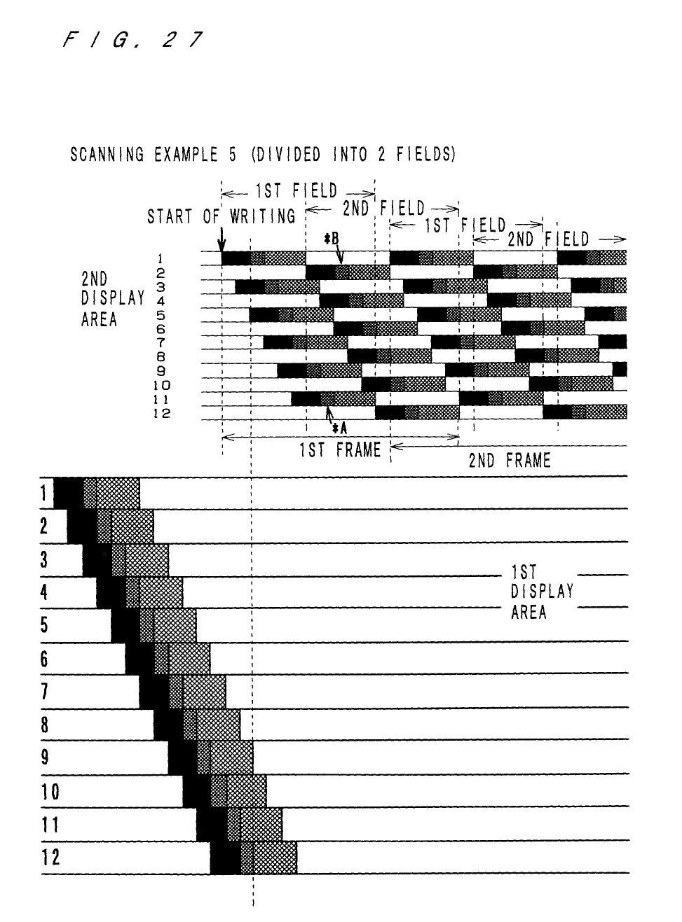

### Scanning Example 5; See FIGS. 27, 28 and 29

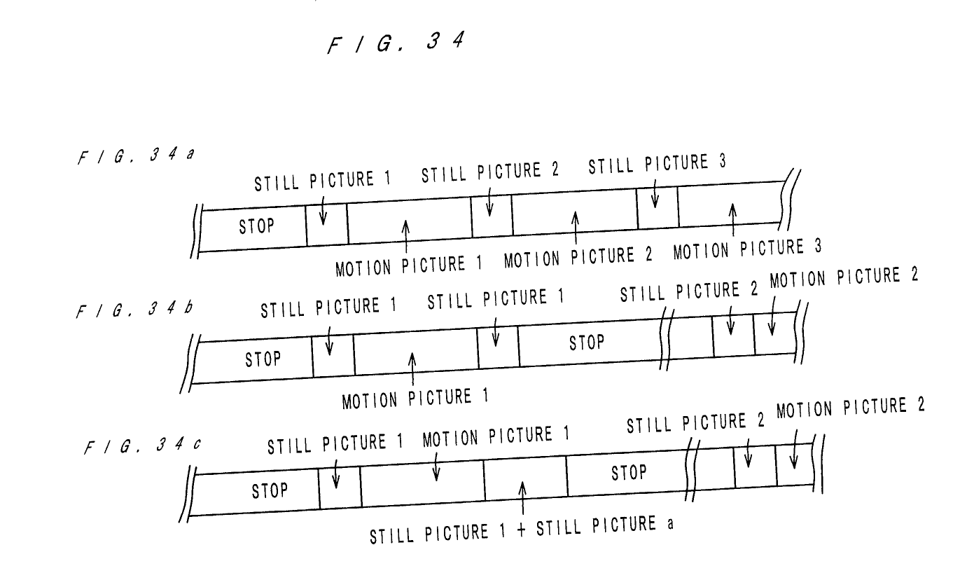

Before carrying out writing in the second display area 12 by interlace scanning, writing in the first display area 11 is carried out by sequential scanning. Once an image is written in the first display area 11, the image is displayed continuously even after the application of a voltage to the first display area 11 is stopped. Therefore, writing in the first display area 11 may be carried out at any appropriate time. The timing of writing in the first display area 11 will be described later referring to FIG. 34.

FIG. 27 shows a case in which writing in the second display area 12 is carried out subsequent to writing in the first display area 11. In the sixth and seventh scanning examples which will be described below, writing in the first display area 11 is carried out in the same way as in the fifth scanning example although it is not shown.

In the fifth scanning example, one frame is divided into two fields, namely, an odd-number field and an even-number field. First, writing is carried out on scanning lines in the odd-number field, and writing is carried out-on scanning lines in the even-number field. The fifth scanning example for writing in the second display area 12 is carried out in the same way as the first scanning example shown by FIG. 6, and the detailed description is omitted.

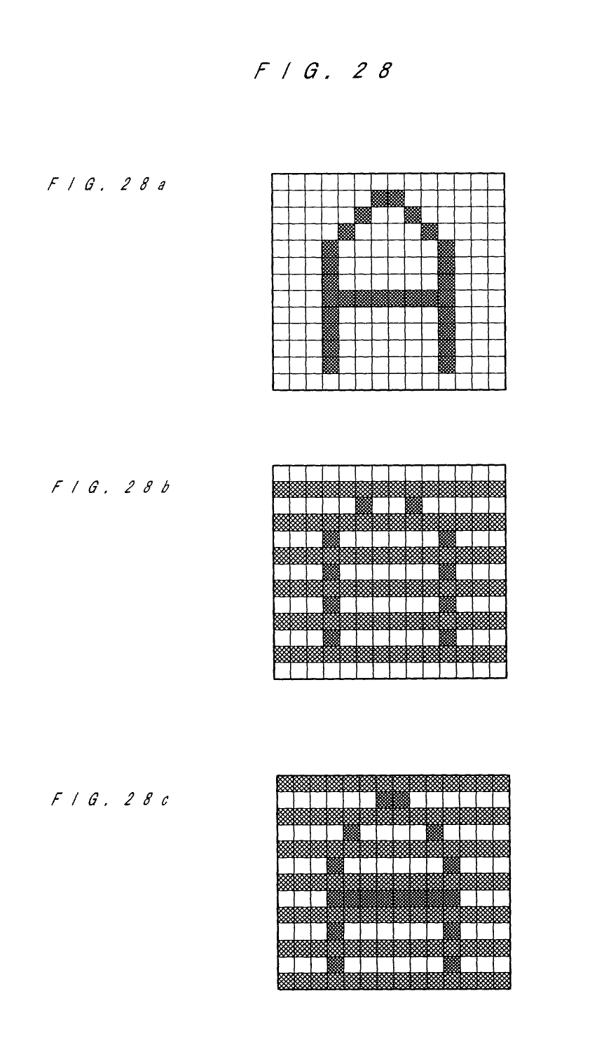

FIG. 28a shows original image data. FIGS. 28b and 28c show a comparative case of writing the image data in a display area composed of square pixels (for example, in the first display area 11) by executing the fifth interlace scanning example. As is apparent from FIGS. 28b and 28c, part of the image data are not displayed in each of the fields, and the image is not easily recognizable.

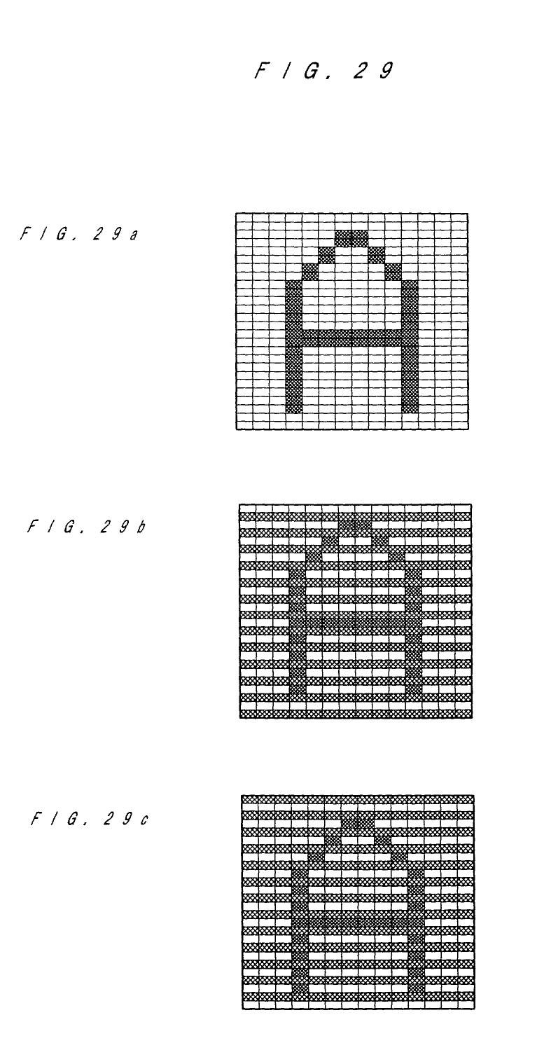

FIG. 29 shows a case of allocating the original image data shown by FIG. 28a to be displayed in the second display area 12 in which the scanning electrodes are arranged at a half pitch. By allocating the original image data in the way shown by FIG. 29a and by performing writing by the fifth scanning example, as FIGS. 29b and 29c show, during the writing, omission of original image data is inhibited, and the image is easily recognizable.

FIGS. 28b and 29b show a state in which writing in the odd-number field is being carried out, and FIGS. 28c and 29c show a state in which writing in the even-number field is being carried out. For example, the length of the selection step can be set within a range from 0.1 msec. to 0.5 msec., and the lengths of the reset step and the evolution step can be set around 25 msec. Accordingly, images can be written one after another at a rate of approximately 10 frames per second although the rate also depends on the number of scanning lines. During the writing, the observer sees no blackouts.

In this fifth scanning example, the resolution of the scanning lines is high, and a scroll display in the direction along the signal lines (vertical direction of the screen) is smooth. This advantage can be seen in the sixth and seventh scanning examples which will be described below.

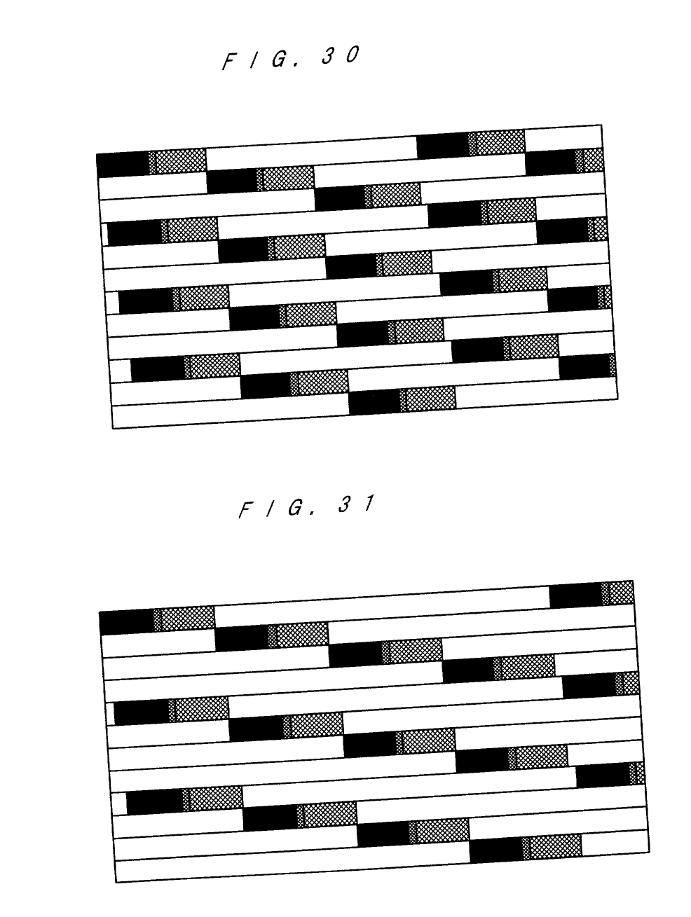

### Scanning Examples 6 and 7; See FIGS. 30, 31 and 32

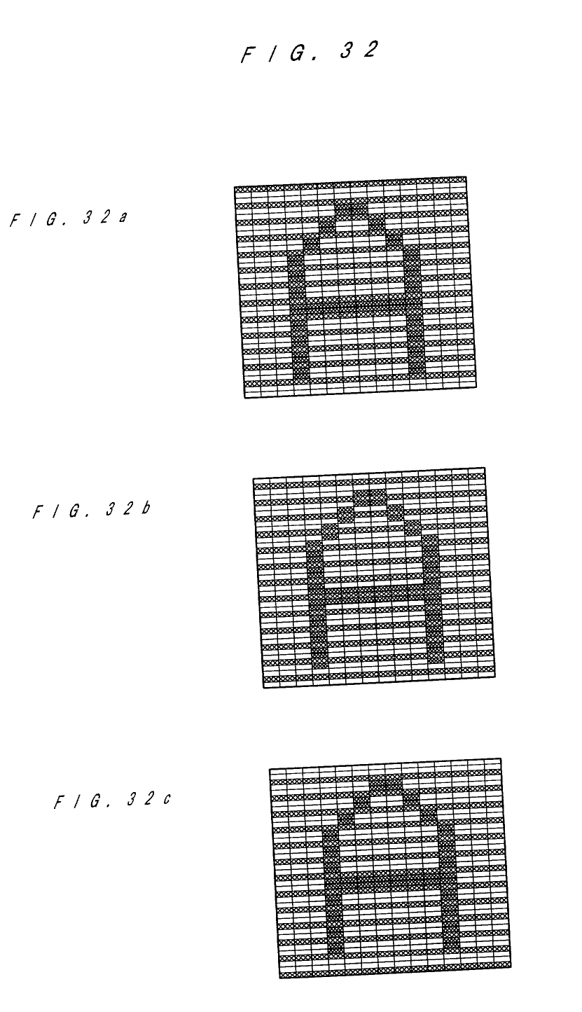

The sixth scanning example is, like the fifth scanning example, mainly to prevent a flicker. As FIG. 30 shows, one frame is divided into three fields in writing an image. In the seventh scanning example, as FIG. 31 shows, one frame is divided into four fields.

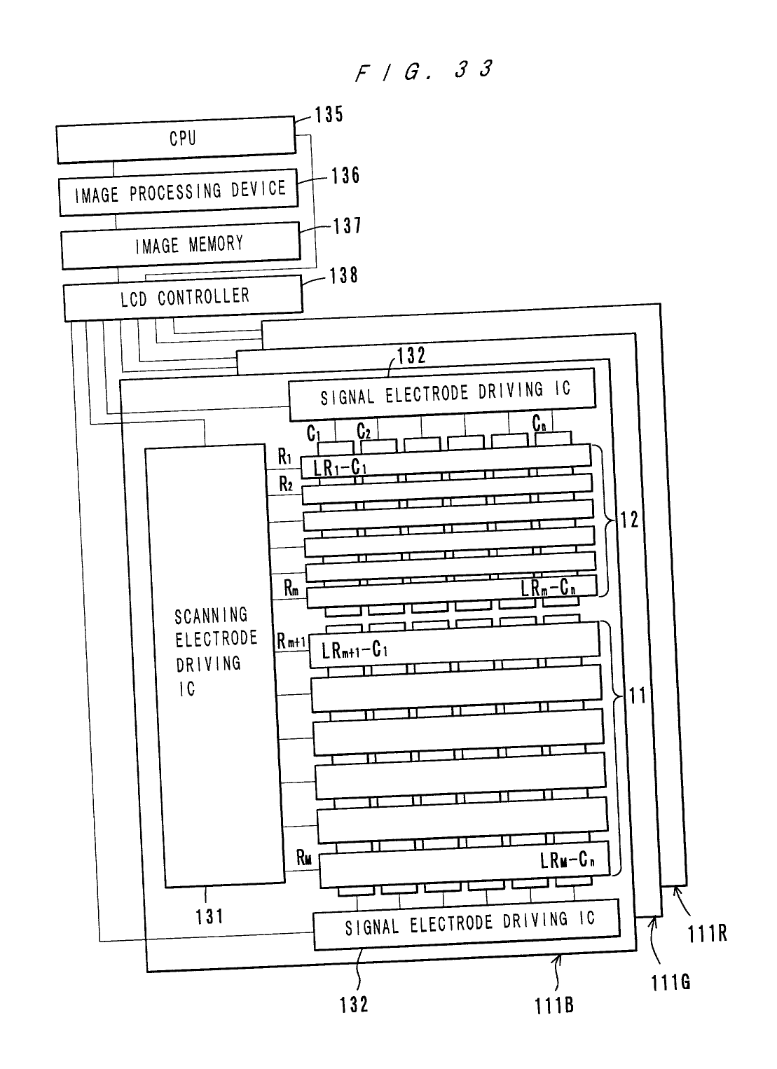

FIG. 32 shows processes of writing an image by the sixth scanning example, and the original image data to be displayed are shown by FIG. 28a. Since the resolution of the scanning lines is higher than that in the fifth scanning example, a smoother image with a higher resolution can be displayed.

As in the case of the sixth scanning example, when an image is written on a larger number of pixels than the number of pixels of original image data, that is, at a smaller pitch than that of original image data, it is necessary to newly produce additional image data. Various ways are possible to produce such additional image data; for example, the method in which data for a middle scanning line are produced by averaging the data for an upper scanning line and the data for a lower scanning line can be adopted. Also, it is possible that the number of fields in performing interlace scanning may be smaller than the ratio of the pixel density in the display area 12 to the pixel density of original image data.

Modification of Third Embodiment; See FIG. 33

In carrying out simple-matrix driving, data signals are sent to pixels on non-selected scanning electrodes through signal electrodes, and crosstalk occurs. In order to avoid this trouble, as FIG. 33 shows, each of the signal electrodes C₁ through Cₙ may be divided into two sections for the first display area 11 and for the second display area 12. In this case, two sets of signal electrode driving ICs 132 are provided so that data signals can be sent to the two sections separately. In this structure, even if writing is carried out on the second display area 12 often, occurrences of crosstalk in the first display area 11 can be avoided.

Writing of Still Picture and Writing of Motion Picture; See FIGS. 34

Next, examples of writing an image (a still picture) on the first display area 11 and writing images (a motion picture) on the second display area 12 are described.

FIG. 34a shows an example of carrying out writing of a still picture on the first display area 11 and writing of a motion picture on the second display area 12 alternately. In FIG. 34a, on the second display area 12, a writing time of a motion picture 1, a writing time of a motion picture 2 and a writing time of a motion picture 3 comes at uniform time intervals. A still picture is written on the first display area 11 between the adjacent writing times on the second display area 12.

FIG. 34b shows an example of carrying out writing of a still picture before and after a writing time of a motion picture. In this case, after writing of a motion picture on the second display area 12, a still picture which has been displayed on the first display area 11 is written on the area 11 again. Thereby, even when the drive of the display is stopped thereafter, the still picture can be displayed continuously on the first display area 11 without being degraded by crosstalk caused by the writing of the motion picture.

In an example shown by FIG. 34c, in addition to carrying out the example shown by FIG. 34b, immediately before stoppage of the drive of the display, a still picture a is written by sequential scanning on the second display area 12 in accordance with the image data of a motion picture which has been displayed on the second display area 12. In the example shown by FIG. 34c, because a motion picture which has been displayed on the second display area 12 is written again by sequential scanning immediately before stoppage of the drive of the display, a high quality image can be displayed continuously after the stoppage of the drive of the display. In writing an image on the second display area 12 by sequential scanning, a plurality of scanning electrodes which comprise a plurality of pixels corresponding to one pixel of image data may be selected at one time.

### Other Embodiments

The structure, the materials and the producing method of the liquid crystal display and the structure of the driving circuit can be arbitrarily determined. The electrodes do not have to be of a structure which permits simple-matrix driving and may be of a structure which uses switching elements such as TFTs. The liquid crystal display may be a monochromatic display which has only one display layer. The pulse waveforms and the timings of applying voltages shown in the drawings are merely examples.

Although the present invention has been described in connection with the preferred embodiments above, it is to be noted that various changes and modifications are possible to those who are skilled in the art. Such changes and modifications are to be understood as being within the scope of the present invention.

What is claimed is:

1. A liquid crystal display apparatus comprising:
a liquid crystal layer comprising liquid crystal;
a plurality of first scanning electrodes aligned in a first direction at a first pitch, each of the first scanning electrodes extending in a second direction substantially orthogonal to the first direction; and
a plurality of signal electrodes facing the first scanning electrodes with the liquid crystal layer sandwiched between the signal electrodes and the first scanning electrodes, the signal electrodes being aligned in the second direction at a second pitch wider than the first pitch and each of the signal electrodes extending in the first direction.

2. The liquid crystal display apparatus according to claim 1, wherein:
pixels are formed at intersections of the first scanning electrodes and the signal electrodes; and
each of the pixels is a rectangle of which shorter sides are parallel to the first direction and of which longer sides are parallel to the second direction.

3. The liquid crystal display apparatus according to claim 2, wherein:
a width of each of the first scanning electrodes defines a length of the shorter sides of each of the pixels; and
a width of each of the signal electrodes defines a length of the longer sides of each of the pixels.

4. The liquid crystal display apparatus according to claim 1, wherein the first pitch is 1/n of the second pitch, wherein n is a natural number not less than 2.

5. The liquid crystal display apparatus according to claim 4, wherein n is 2.

6. The liquid crystal display apparatus according to claim 1, wherein the first pitch is 1/n of the second pitch, wherein n is a number more than 1 and less than 2.

7. The liquid crystal display apparatus according to claim 6, further comprising:
a scanning electrode driver which is connected to the first scanning electrodes so as to apply voltages thereto;
a signal electrode driver which is connected to the signal electrodes so as to apply voltages thereto; and
a controller which is connected to the scanning electrode driver and the signal electrode driver so as to control the scanning electrode driver and the signal electrode driver.

8. The liquid crystal display according to claim 7, wherein the controller produces display data from original image data by carrying out an interpolation of the original image data with respect to the second direction and controls the scanning electrode driver and the signal electrode driver in accordance with the display data.

9. The liquid crystal display according to claim 8, wherein a number of lines in the second direction of the display data is n times a number of lines in the second direction of the original image data.

10. The liquid crystal display apparatus according to claim 9, wherein n is 1.5.

11. The liquid crystal display apparatus according to claim 10, wherein the controller produces display data for pixels on one scanning line from original image data for pixels on two successive scanning lines.

12. The liquid crystal display apparatus according to claim 11, wherein the controller produces display data for pixels on one scanning line by averaging image data for pixels on two successive scanning lines.

13. The liquid crystal display apparatus according to claim 11, wherein the controller produces display data for pixels on one scanning line by comparing original image data for pixels on two successive scanning lines.

14. The liquid crystal display apparatus according to claim 7, further comprising:
a memory for storing font data which are exclusively used in the liquid crystal display apparatus,
wherein the controller uses the font data in a case where the original image data contains text data.

15. The liquid crystal display apparatus according to claim 1, further comprising:
a plurality of second scanning electrodes aligned in the first direction at a third pitch wider than the first pitch, each of the second scanning electrodes extending in the second direction.

16. The liquid crystal display apparatus according to claim 15, further comprising:
a scanning electrode driver which is connected to the first scanning electrodes and the second scanning electrodes so as to apply voltages thereto;
a signal electrode driver which is connected to the signal electrodes so as to apply voltages thereto; and
a controller which is connected to the scanning electrode driver and the signal electrode driver so as to control the scanning electrode driver and the signal electrode driver.

17. The liquid crystal display apparatus according to claim 16, wherein the controller controls the scanning electrode driver and the signal electrode driver to scan the second scanning electrodes by interlace scanning.

18. The liquid crystal display apparatus according to claim 16, wherein the controller controls the scanning electrode driver and the signal electrode driver to scan the first scanning electrodes in order of the alignment thereof.

19. The liquid crystal display apparatus according to claim 16, wherein the scanning electrode driver comprises:
at least one first driver IC which is connected to some of the first scanning electrodes and which is located at a first end of the scanning electrodes with respect to the second direction;
at least one second driver IC which is connected to the others of the scanning electrodes and which is located at a second end, which is opposite to the first end, of the scanning electrodes; and
at least one third driver IC which is connected to the second scanning electrodes and which is located at the first end.

20. The liquid crystal display according to claim 15, wherein the signal electrodes are shared to be coupled with the first scanning electrodes and the second scanning electrodes.

21. The liquid crystal display apparatus according to claim 15, wherein the signal electrodes comprise:
a plurality of first signal electrodes which are coupled with the first scanning electrodes; and
a plurality of second signal electrodes which are coupled with the second scanning electrodes.

22. The liquid crystal display apparatus according to claim 21, further comprising:
at least one first driver IC which is connected to the first signal electrodes and which is located at a first end of the signal electrodes with respect to the first direction; and
at least one second driver IC which is connected to the second signal electrodes and which is located at a second end, which is opposite to the first end, of the signal electrodes.

23. The liquid crystal display apparatus according to claim 15, wherein the first pitch is 1/n of the second pitch, wherein n is a natural number not less than 2.

24. The liquid crystal display apparatus according to claim 23, further comprising:
a scanning electrode driver which is connected to the first scanning electrodes and the second scanning electrodes so as to apply voltages thereto;
a signal electrode driver which is connected to the first signal electrodes so as to apply voltages thereto; and
a controller which is connected to the scanning electrode driver and to the signal electrode driver so as to control the scanning electrode driver and the signal electrode driver.

25. The liquid crystal display apparatus according to claim 24, wherein the controller controls the scanning electrode driver and the signal electrode driver to reset the liquid crystal of the liquid crystal layer and then to write an image by interlace scanning.

26. The liquid crystal display apparatus according to claim 25, wherein:
in carrying out the interlace scanning, a frame is divided into n fields, wherein n is a natural number not less than 2; and
the first pitch is 1/n of the second pitch.

27. The liquid crystal display apparatus according to claim 1, wherein the liquid crystal has a memory effect.

28. The liquid crystal display apparatus according to claim 27, wherein the liquid crystal exhibits a cholesteric phase.

29. The liquid crystal display apparatus according to claim 28, wherein the liquid crystal comprises a nematic liquid crystal compound and a chiral agent.

30. A liquid crystal display apparatus comprising:
a liquid crystal layer comprising liquid crystal;
a plurality of scanning electrodes aligned in a first direction at a first pitch, each of the scanning electrodes extending in a second direction substantially orthogonal to the first direction; and
a plurality of signal electrodes facing the scanning electrodes with the liquid crystal layer sandwiched between the signal electrodes and the scanning electrodes, the signal electrodes being aligned in the second direction at a second pitch and each of the signal electrodes extending in the first direction,
wherein one of the first pitch and the second pitch is 1/n of the other, wherein 1<n<2.

31. The liquid crystal display apparatus according to claim 30, wherein n is 1.5.

32. The liquid crystal display apparatus according to claim 30, wherein the first pitch is 1/n of the second pitch.

33. The liquid crystal display apparatus according to claim 32, wherein n is 1.5.

34. The liquid crystal display apparatus according to claim 30, wherein the liquid crystal has a memory effect.

35. The liquid crystal display apparatus according to claim 34, wherein the liquid crystal exhibits a cholesteric phase.

36. The liquid crystal display apparatus according to claim 35, wherein the liquid crystal comprises a nematic liquid crystal compound and a chiral agent.

37. A liquid crystal display apparatus comprising:
a liquid crystal layer comprising liquid crystal;
a plurality of first scanning electrodes aligned in a first direction at a first pitch, each of the first scanning electrodes extending in a second direction substantially orthogonal to the first direction;
a plurality of second scanning electrodes aligned in the first direction at a second pitch that is different from the first pitch, each of the second scanning electrodes extending in the second direction; and
a plurality of signal electrodes facing the first and second scanning electrodes with the liquid crystal layer sandwiched between the signal electrodes and the first and second scanning electrodes, the signal electrodes being aligned in the second direction at a third pitch and each of the signal electrodes extending in the first direction.

38. The liquid crystal display apparatus according to claim 37, wherein the signal electrodes comprise:
a plurality of first signal electrodes which are coupled with the first scanning electrodes; and
a plurality of second signal electrodes which are coupled with the second scanning electrodes.

39. The liquid crystal display apparatus according to claim 37, wherein the signal electrodes are shared to be coupled with the first scanning electrodes and the second scanning electrodes.

40. The liquid crystal display apparatus according to claim 37, wherein the first pitch is 1/n of the second pitch, wherein n is a natural number not less than 2.

41. The liquid crystal display apparatus according to claim 37, wherein the liquid crystal has a memory effect.

42. The liquid crystal display apparatus according to claim 41, wherein the liquid crystal exhibits a cholestric phase.

43. The liquid crystal display apparatus according to claim 42, wherein the liquid crystal comprises a nematic liquid crystal compound and a chiral agent.
